(19) United States
(12) Patent Application Publication
(10) Pub. No.: US 2022/0261874 A1
(43) Pub. Date: Aug. 18, 2022

(54) NON-TRANSITORY COMPUTER READABLE MEDIUM STORING EVENT PROVISION PROGRAM AND EVENT PROVISION SYSTEM

(71) Applicant: SQUARE ENIX CO., LTD., Tokyo (JP)

(72) Inventors: MAKOTO TSUDA, Tokyo (JP); KEITA SHIBATA, Tokyo (JP); MANAMI FUSHIKI, Tokyo (JP)

(73) Assignee: SQUARE ENIX CO., LTD., Tokyo (JP)

(21) Appl. No.: 17/649,705

(22) Filed: Feb. 2, 2022

(30) Foreign Application Priority Data
Feb. 12, 2021 (JP) 2021-021095

(51) Int. Cl. G06Q 30/06; G06T 19/00

(52) U.S. Cl. CPC G06Q 30/0631; G06Q 30/0641; G06T 19/006

(57) ABSTRACT

A non-transitory computer readable medium storing an event provision program causing a server to implement an object display function of displaying a first object that is a virtual object on a display device in a superimposed manner on a real space, a representation control function of controlling a representation using one or more virtual objects including the first object, and a permission acquisition information display function of displaying information (permission acquisition information) for causing a user to acquire a predetermined permission for a product or a service related to the object, the event, or the representation on the display device is provided.

### CROSS-REFERENCE TO RELATED APPLICATION

This application claims priority to and the benefit of Japanese Patent Application No. 2021-021095, filed on Feb. 12, 2021, the disclosure of which is expressly incorporated herein by reference in its entirety for any purpose.

### BACKGROUND

At least one embodiment of the present disclosure relates to a non-transitory computer readable medium storing an event provision program and an event provision system.

For example, JPA2014-517566 discloses a method for using augmented reality together with a live event. The method includes a step of receiving a data stream corresponding to the live event by a computer control device. The data stream includes a live video. The live video includes a live object. The method includes a step of receiving an input from a user by the computer control device. The input from the user affects a behavior of a virtual object. The method includes a step of presenting the live event augmented with the virtual object by the computer control device.

### SUMMARY

In a case where the event is performed by displaying (displaying in AR) an artist of a live music, an actor of a stage theatrical play, or the like in a superimposed manner on a real space as a character or an object, the live event can be performed in a space (hereinafter, referred to as an augmented space) that is augmented using augmented reality. Furthermore, in a case where a product or a service related to the event is provided in accordance with the event, goods sales or service can be provided to a participant of the event in the augmented space.

An object of at least one embodiment of the present disclosure is to solve the above problem and enable an event to be held using augmented reality and enable goods sales and service provision in the event.

From a non-limiting viewpoint, a non-transitory computer readable medium storing an event provision program according to one embodiment of the present disclosure causes a server to implement an object display function of displaying a first object that is a virtual object on a display device in a superimposed manner on a real space, a representation control function of controlling a representation using one or more virtual objects including the first object, and a permission acquisition (authority obtaining) information display function of displaying information (hereinafter, referred to as “permission acquisition information”) for causing a user to acquire a predetermined permission for a product or a service related to the object, the event, or the representation on the display device.

From a non-limiting viewpoint, an event provision system according to one embodiment of the present disclosure is an event provision system including a communication network, a server, and a user terminal, and includes object display means for displaying a first object that is a virtual object on a display device in a superimposed manner on a real space, representation control means for controlling a representation using one or more virtual objects including the first object, and permission acquisition information display means for displaying information (hereinafter, referred to as “permission acquisition information” or “authority obtaining information”) for causing a user to acquire a predetermined permission for a product or a service related to the object, the event, or the representation on the display device.

From a non-limiting viewpoint, a non-transitory computer readable medium storing an event provision program according to one embodiment of the present disclosure causes a user terminal to implement an object display function of displaying a first object that is a virtual object on a display device in a superimposed manner on a real space, a representation control function of controlling a representation using one or more virtual objects including the first object, and a permission acquisition information display function of displaying information (hereinafter, referred to as “permission acquisition information”) for causing a user to acquire a predetermined permission for a product or a service related to the object, the event, or the representation on the display device.

Each embodiment of the present application solves one or two or more deficiencies.

### DETAILED DESCRIPTION

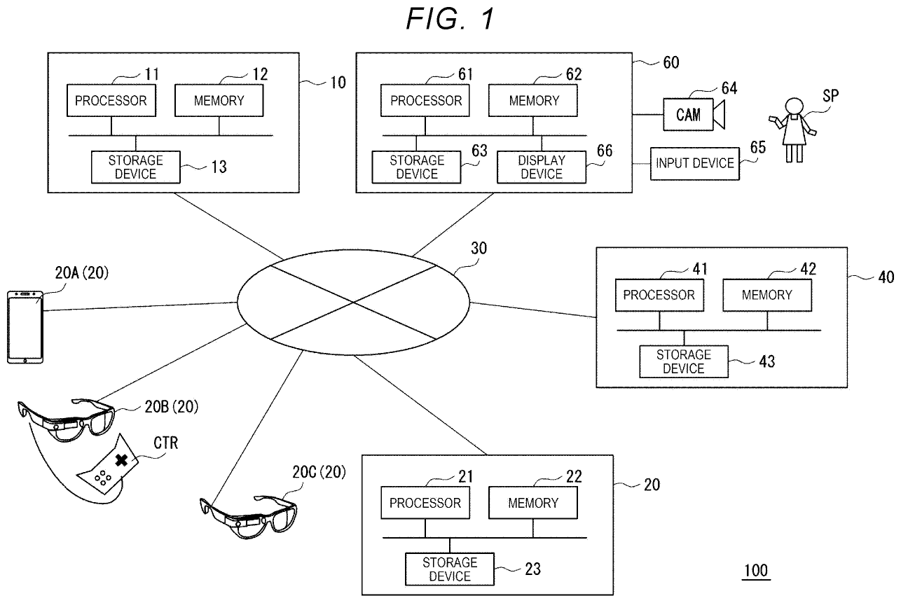

FIG. 1 is a diagram illustrating an example of a configuration of an event provision system according to at least one embodiment of the present disclosure.

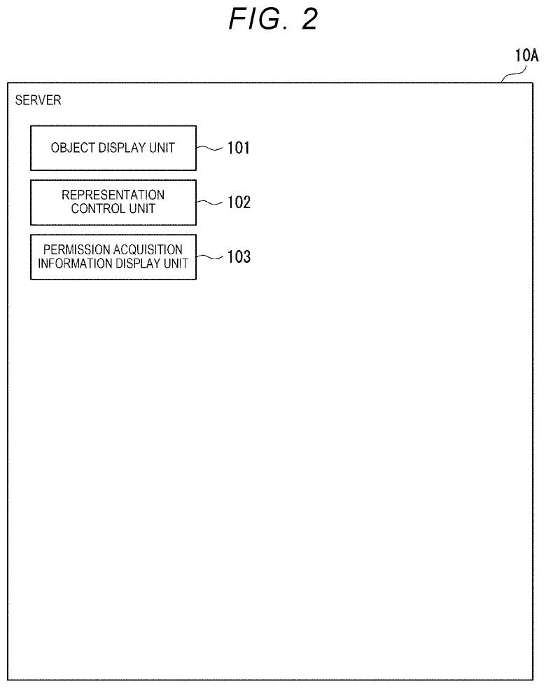

FIG. 2 is a block diagram illustrating a configuration of a server according to at least one embodiment of the present disclosure.

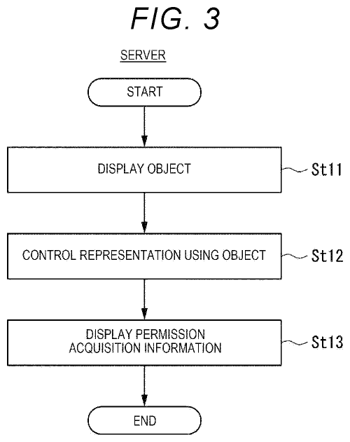

FIG. 3 is a flowchart illustrating an example of an event provision process according to at least one embodiment of the present disclosure.

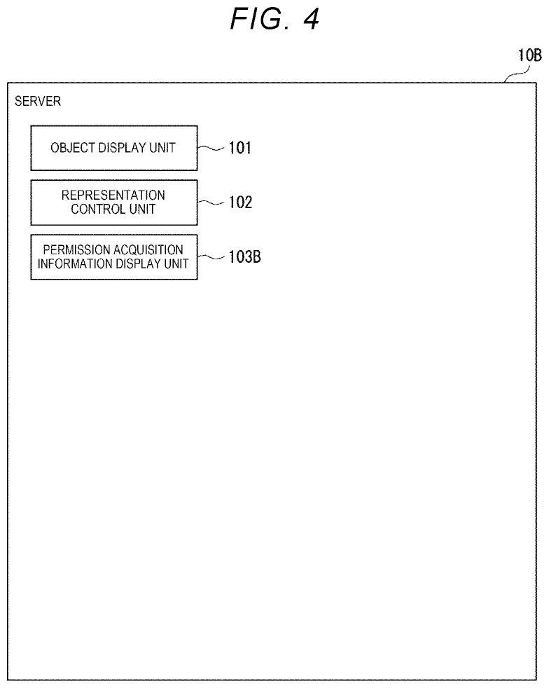

FIG. 4 is a block diagram illustrating a configuration of the server according to at least one embodiment of the present disclosure.

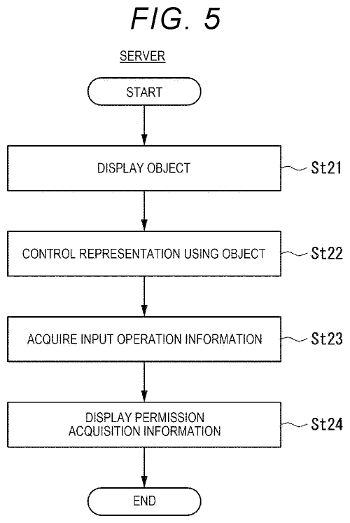

FIG. 5 is a flowchart illustrating an example of the event provision process according to at least one embodiment of the present disclosure.

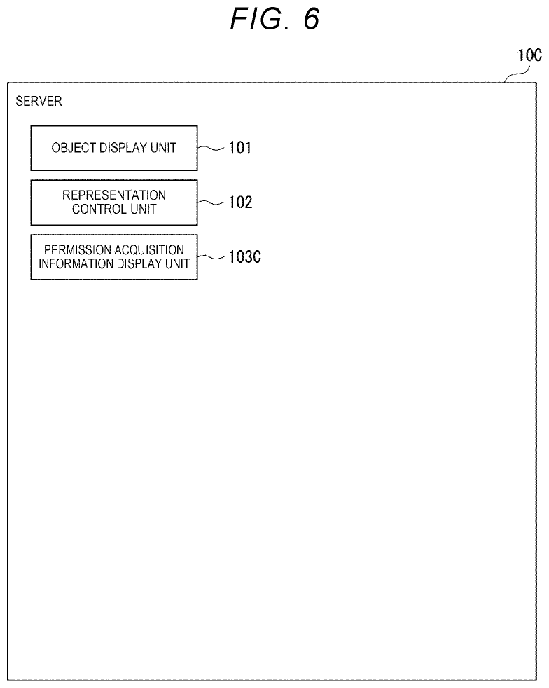

FIG. 6 is a block diagram illustrating a configuration of the server according to at least one embodiment of the present disclosure.

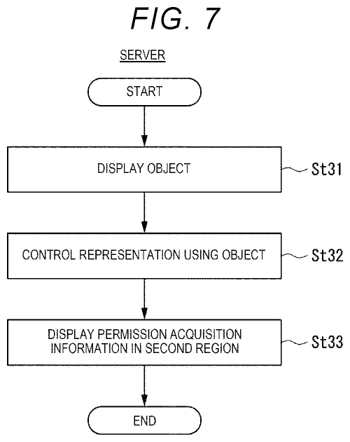

FIG. 7 is a flowchart illustrating an example of the event provision process according to at least one embodiment of the present disclosure.

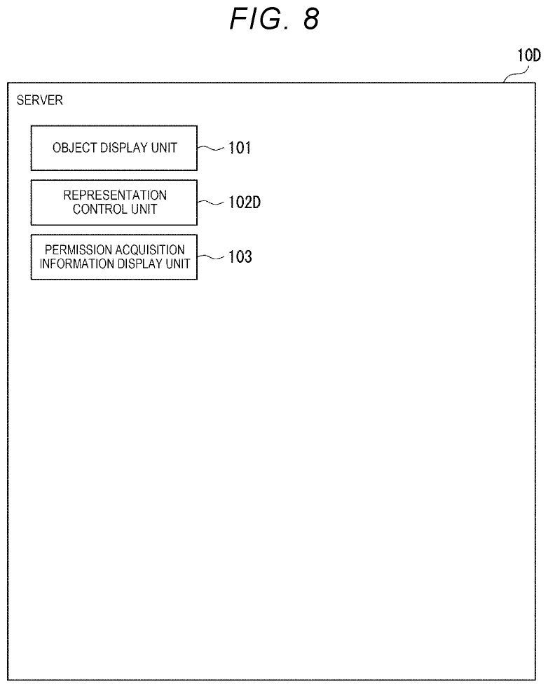

FIG. 8 is a block diagram illustrating a configuration of the server according to at least one embodiment of the present disclosure.

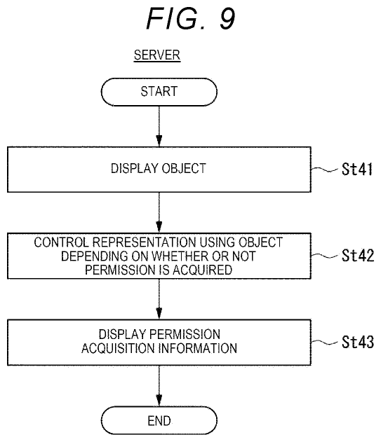

FIG. 9 is a flowchart illustrating an example of the event provision process according to at least one embodiment of the present disclosure.

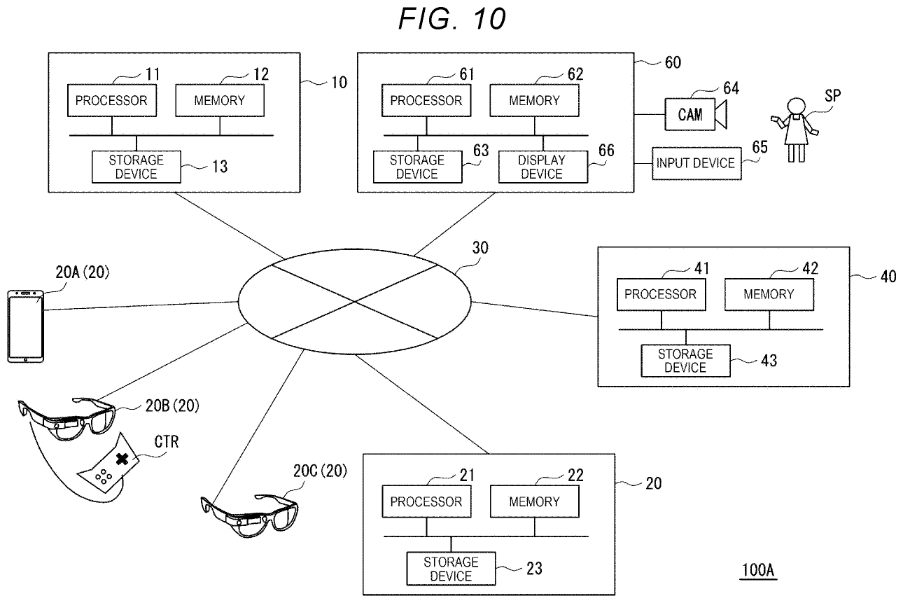

FIG. 10 is a diagram illustrating an example of a configuration of the event provision system according to at least one embodiment of the present disclosure.

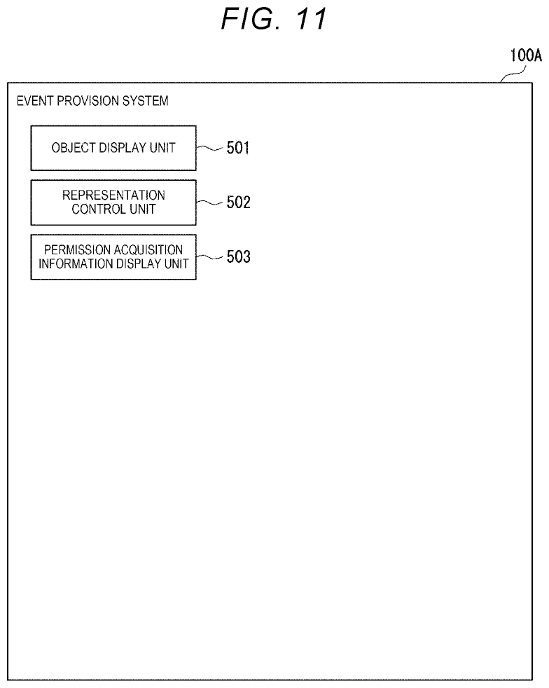

FIG. 11 is a block diagram illustrating a configuration of the event provision system according to at least one embodiment of the present disclosure.

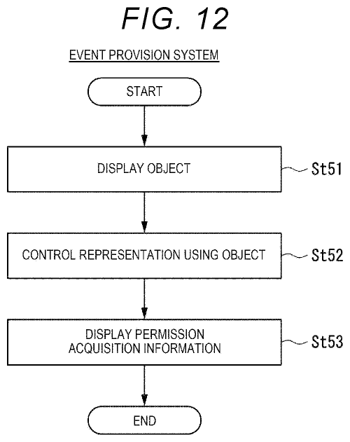

FIG. 12 is a flowchart illustrating an example of the event provision process according to at least one embodiment of the present disclosure.

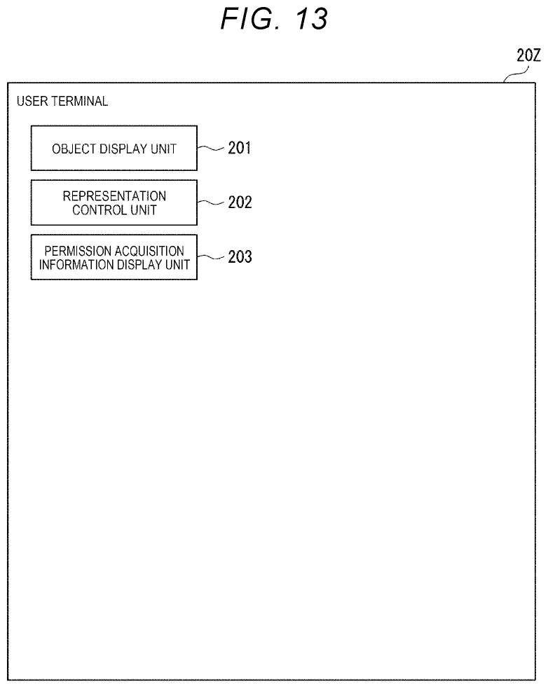

FIG. 13 is a block diagram illustrating a configuration of a user terminal according to at least one embodiment of the present disclosure.

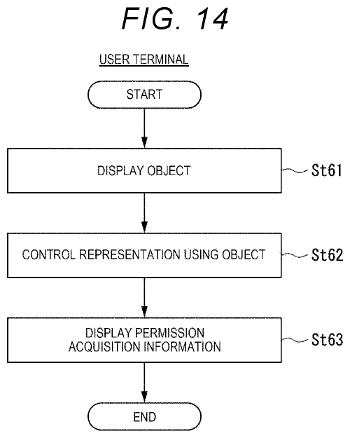

FIG. 14 is a flowchart illustrating an example of the event provision process according to at least one embodiment of the present disclosure.

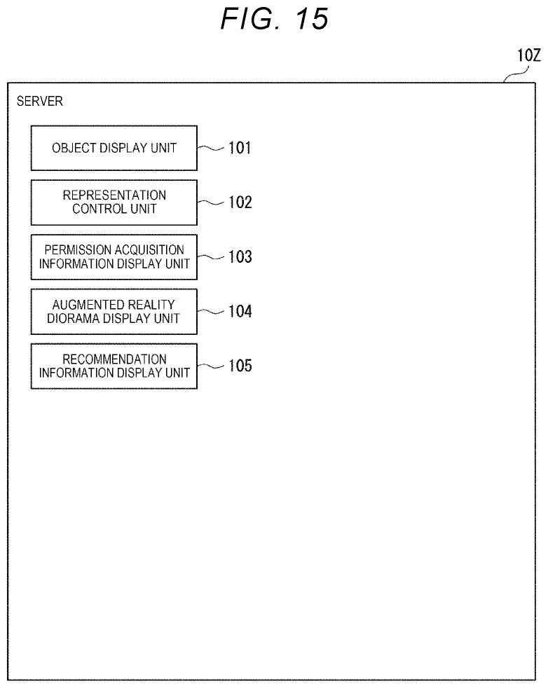

FIG. 15 is a block diagram illustrating a configuration of the server according to at least one embodiment of the present disclosure.

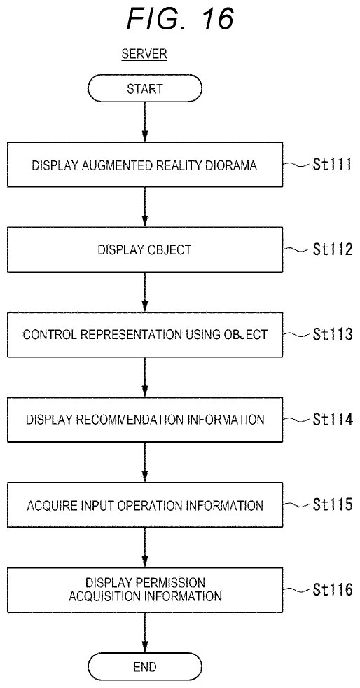

FIG. 16 is a flowchart illustrating an example of the event provision process according to at least one embodiment of the present disclosure.

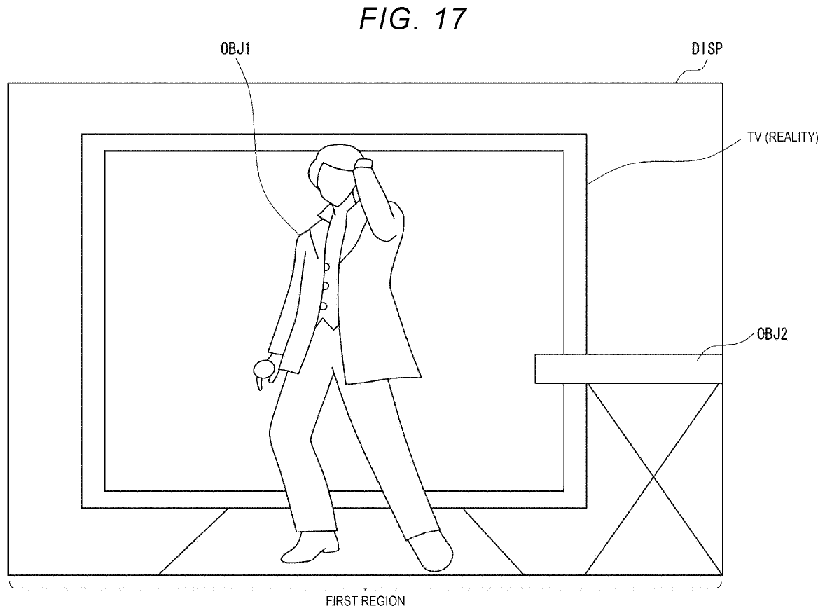

FIG. 17 is a conceptual diagram illustrating a display example by a display device according to at least one embodiment of the present disclosure.

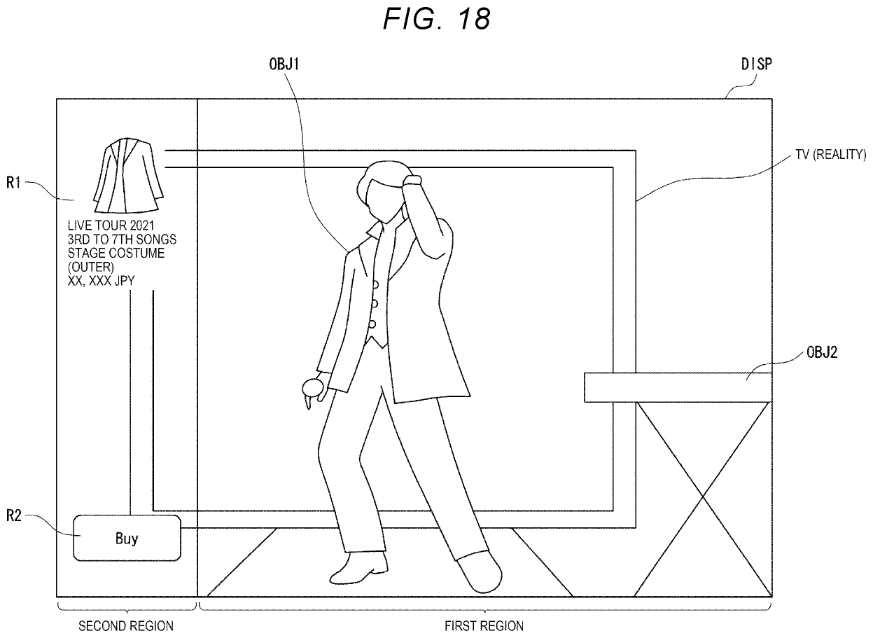

FIG. 18 is a conceptual diagram illustrating a display example by the display device according to at least one embodiment of the present disclosure.

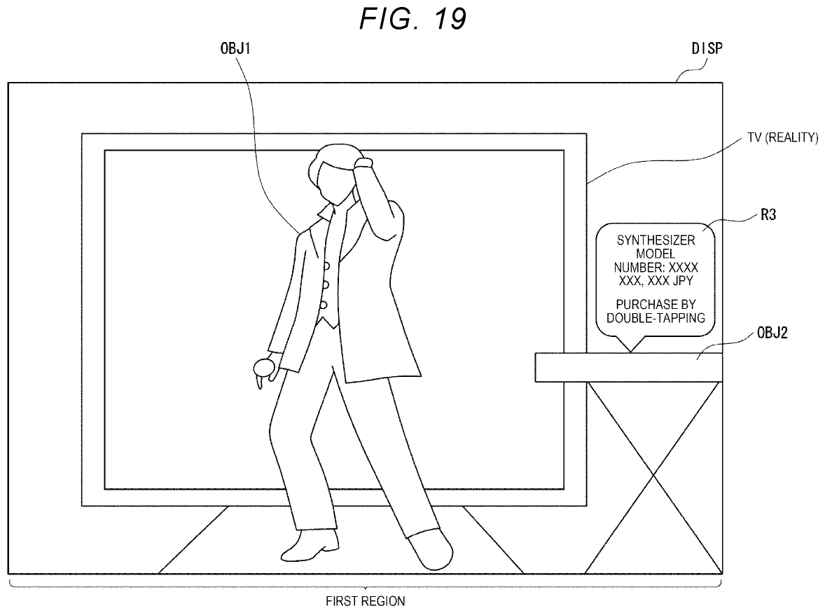

FIG. 19 is a conceptual diagram illustrating a display example by the display device according to at least one embodiment of the present disclosure.

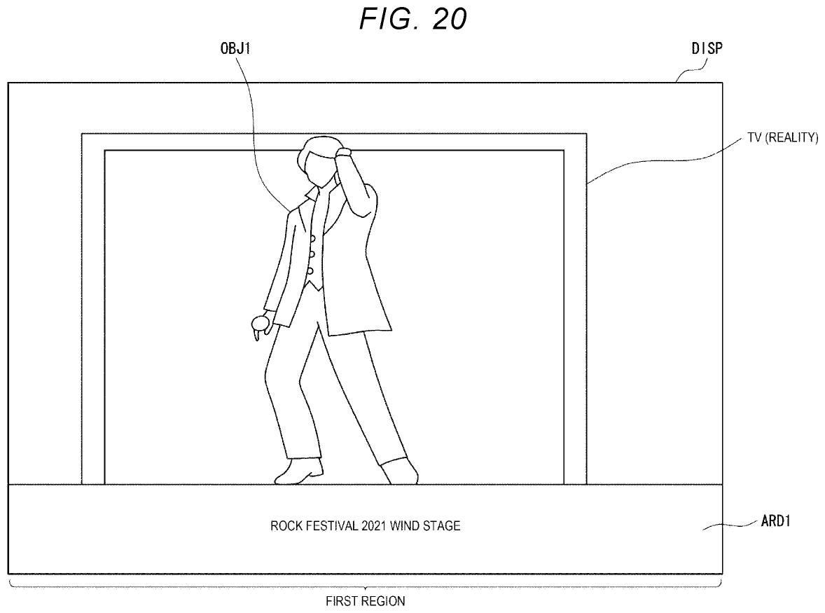

FIG. 20 is a conceptual diagram illustrating a display example by the display device according to at least one embodiment of the present disclosure.

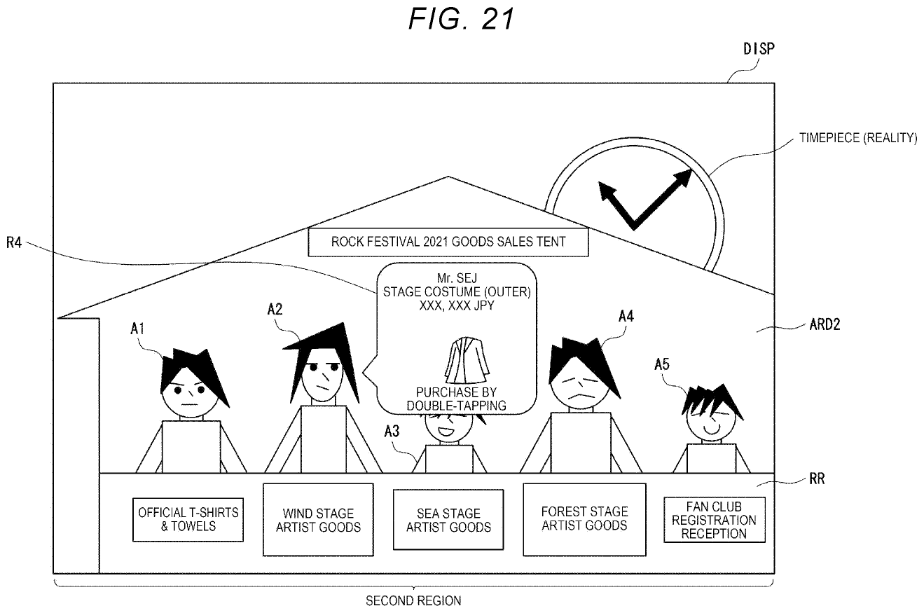

FIG. 21 is a conceptual diagram illustrating a display example by the display device according to at least one embodiment of the present disclosure.

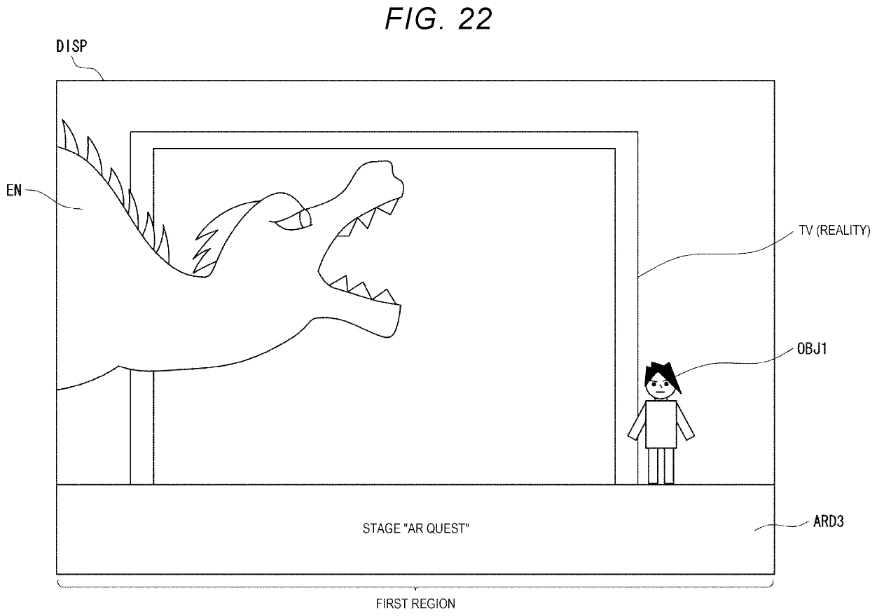

FIG. 22 is a conceptual diagram illustrating a display example by the display device according to at least one embodiment of the present disclosure.

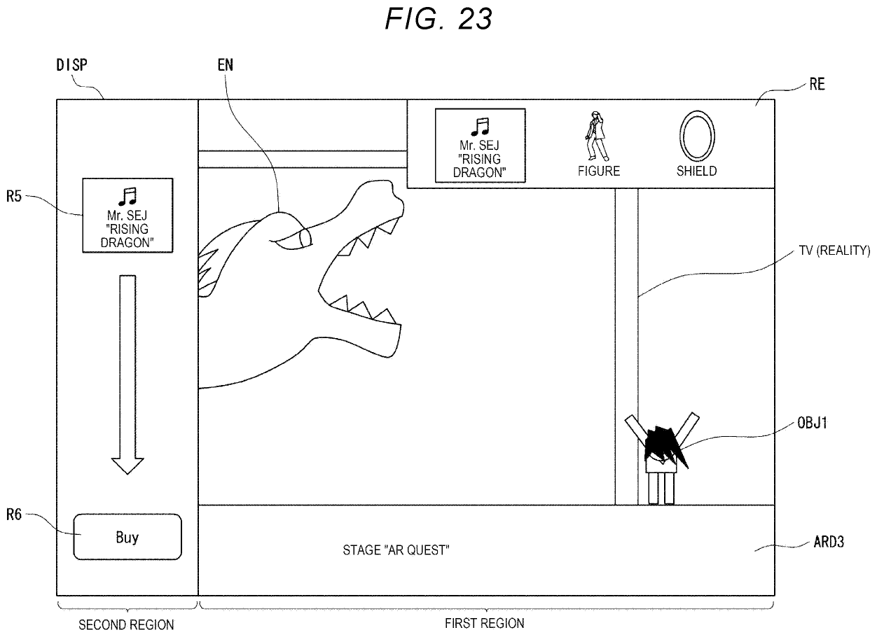

FIG. 23 is a conceptual diagram illustrating a display example by the display device according to at least one embodiment of the present disclosure.

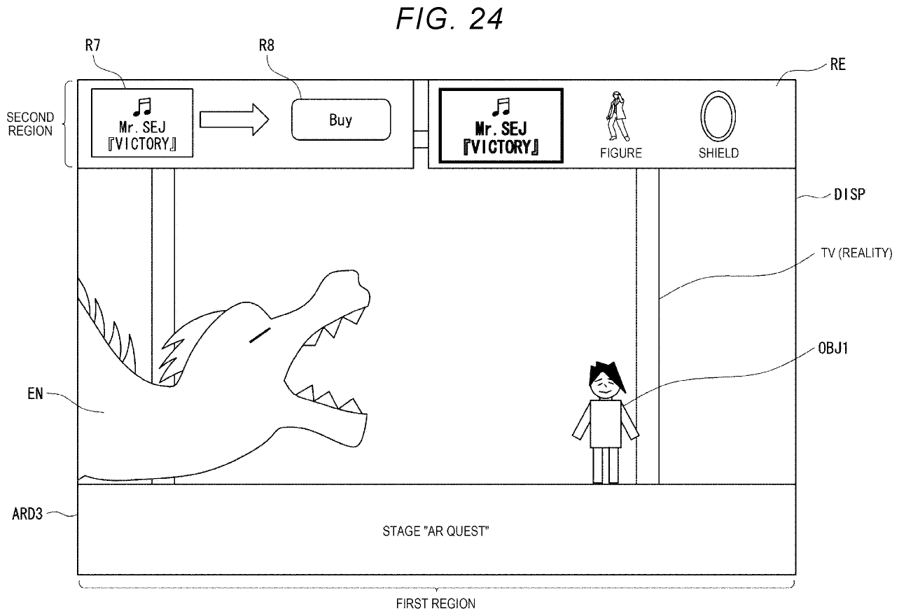

FIG. 24 is a conceptual diagram illustrating a display example by the display device according to at least one embodiment of the present disclosure.

### DESCRIPTION OF EMBODIMENTS

Hereinafter, an example of embodiments of the present disclosure will be described with reference to the drawings. Various constituents in the example of each embodiment described below can be appropriately combined without contradiction or the like. In addition, contents described as an example of a certain embodiment may not be described in other embodiments. In addition, contents of operations or processes not related to a characteristic part of each embodiment may be omitted. Furthermore, an order of various processes constituting various flows or sequences described below may be changed without contradiction or the like in process contents.

### First Embodiment

A summary of a first embodiment of the present disclosure will be described. Hereinafter, an event provision program executed in a server will be illustratively described as the first embodiment.

FIG. 1 is a diagram illustrating an example of a configuration of an event provision system according to at least one embodiment of the present disclosure. An event provision system 100 includes an event provision process server 10 (server 10) and a user terminal 20 used by a user of the event provision system 100. Each of user terminals 20A, 20B, and 20C is an example of the user terminal 20. The configuration of the event provision system 100 is not limited thereto. For example, the event provision system 100 may have a configuration in which a plurality of users use a single user terminal. The event provision system 100 may include a plurality of servers. For example, the event provision system 100 may further include another server 40.

The event provision system 100 may further include a receptionist apparatus 60. For example, a receptionist SP who receives the user visiting a goods sales tent (refer to FIG. 21), described later, uses the receptionist apparatus 60. Specific examples of the receptionist apparatus 60 include a server apparatus, a client apparatus, the user terminal described later, and the like.

Each of the server 10, the user terminal 20, the other server 40, and the receptionist apparatus 60 is communicably connected to a communication network 30 such as the Internet. Connection among the server 10, the user terminal 20, the other server 40, and the receptionist apparatus 60 through the communication network 30 may be wired connection or wireless connection. For example, a plurality of the user terminals 20 may be connected to the communication network 30 by performing data communication with a base station managed by a communication service provider using a wireless communication line.

The event provision system 100, by including the server 10 and the user terminal 20, implements various functions for executing various processes in accordance with an operation of the user.

The server 10 includes a processor 11, a memory 12, and a storage device 13. For example, the processor 11 is a central processing device such as a central processing unit (CPU) that performs various calculations and controls. In addition, in a case where the server 10 includes a graphics processing unit (GPU), the GPU may perform a part of the various calculations and controls. The server 10 executes various information processes by the processor 11 using data read into the memory 12 and stores obtained process results in the storage device 13 as needed.

The storage device 13 has a function as a storage medium storing various information. A configuration of the storage device 13 is not particularly limited but is preferably a configuration capable of storing all of various information necessary for controls performed in the event provision system 100 from a viewpoint of reducing a process load exerted on the user terminal 20. Such examples include an HDD and an SSD. However, the storage device storing various information may have a storage region in an accessible state from the server 10 and, for example, may be configured to have a dedicated storage region outside the server 10. The server 10 is managed by a manager or the like of the event provision system 100 and has various functions for providing information related to various processes to the plurality of user terminals 20. The server 10 is configured with an information processing apparatus such as a game server that can render AR display data.

The user terminal 20 is configured with a communication terminal that can provide an information service accompanying AR display to the user. Examples of the communication terminal include, for example, a mobile phone terminal 20A such as a smartphone and AR glasses 20B and 20C. The communication terminal may be a stationary game apparatus, a portable game apparatus, a personal computer, a gaming PC, or a so-called wearable device, or a combination of a plurality of the communication terminals. The configuration of the user terminal that may be included in the event provision system 100 is not limited thereto and may be a configuration in which the user may visually recognize the display in AR.

The user terminal 20 includes a processor 21, a memory 22, and a storage device 23. For example, the processor 21 is a central processing device such as a central processing unit (CPU) that performs various calculations and controls. In addition, in a case where the user terminal 20 includes a graphics processing unit (GPU), the GPU may perform a part of the various calculations and controls. The user terminal 20 executes various information processes by the processor 21 using data read into the memory 22 and stores obtained process results in the storage device 23 as needed. The storage device 23 has a function as a storage medium storing various information.

The user terminal 20 is connected to the communication network 30 and includes hardware and software for executing various processes by communicating with the server 10, the other server 40, or the receptionist apparatus 60. Each of the plurality of user terminals 20 may be configured to be capable of directly communicating with each other without the server 10, the other server 40, or the receptionist apparatus 60.

The user terminal 20 may incorporate a display device. The display device may be connected to the user terminal 20 in a wireless or wired manner. The display device displays images such as a still picture and a motion picture. The display device may display a game screen. The display device may display a shape of the receptionist SP based on data obtained directly from the receptionist apparatus 60 through the communication network 30 or further via the server 10 or the like. In addition, the display device can perform augmented reality (AR) display superimposed on a real space. Examples of the display device include a hologram display device that can perform hologram display, and a projection device that projects images (including the game screen) to a screen or the like. In the example in FIG. 1, a touch panel screen included in the mobile phone terminal 20A, AR displays included in the AR glasses 20B and 20C, and the like correspond to the display device.

The user terminal 20 may incorporate an input device. In addition, the input device may be connected to the user terminal 20 in a wireless or wired manner. The input device receives an operation input provided by the user. The processor included in the server 10 or the processor included in the user terminal 20 executes various control processes in accordance with the operation input provided by the user. Examples of the input device include the touch panel screen included in the mobile phone terminal 20A, a controller CTR that is connected to the AR glasses 20B in a wireless or wired manner, and the like. In addition, a camera included in the user terminal 20 may correspond to the input device. The user provides the operation input (gesture input) by a gesture such as moving a hand in front of the camera.

Besides, the user terminal 20 may include another output device such as a speaker. The other output device outputs various information to the user. For example, the output information includes a voice of the receptionist SP. The other output device may output voice information indicating a product purchased by the user or a content of a provided service received by the user. The other output device is not limited to a voice output device and may output other types of information. Besides, the other output device using haptic technology may output tactile information.

The other server 40 includes a processor 41, a memory 42, and a storage device 43. For example, the processor 41 is a central processing device such as a central processing unit (CPU) that performs various calculations and controls. In addition, in a case where the other server 40 includes a graphics processing unit (GPU), the GPU may perform a part of the various calculations and controls. The other server 40 executes various information processes by the processor 41 using data read into the memory 42 and stores obtained process results in the storage device 43 as needed.

The storage device 43 has a function as a storage medium storing various information. The configuration of the storage device 43 is not limited thereto. The storage device storing various information may have a storage region in an accessible state from the other server 40 and, for example, may be configured to have a dedicated storage region outside the other server 40. The other server 40 may be managed by the manager or the like of the event provision system 100 or may be managed by other persons. The other server 40 has various functions for providing information related to various processes to the plurality of user terminals 20. For example, the other server 40 may be a server that manages manufacturing and delivery of an actual article. The other server 40 may be a server that manages distribution of a motion picture related to a live event.

The receptionist apparatus 60 includes a processor 61, a memory 62, and a storage device 63. For example, the processor 61 is a central processing device such as a central processing unit (CPU) that performs various calculations and controls. In addition, in a case where the receptionist apparatus 60 includes a graphics processing unit (GPU), the GPU may perform a part of the various calculations and controls. The receptionist apparatus 60 executes various information processes by the processor 61 using data read into the memory 62 and stores obtained process results in the storage device 63 as needed. The storage device 63 has a function as a storage medium storing various information.

The receptionist apparatus 60 is connected to the communication network 30 and includes hardware and software for executing various processes by communicating with the server 10, the user terminal 20, or the other server 40.

The receptionist apparatus 60 includes a camera 64 and an input device 65. For example, the camera 64 images the receptionist SP who is a salesperson of the goods sales tent (refer to FIG. 21). In a case where the user purchases the product or the like, captured image data in which a shape of the receptionist SP is captured is used for receiving the user by the receptionist SP in a cashier region described later. The input device 65 receives an operation input provided by the receptionist SP or the like. The processor 61 included in the receptionist apparatus 60 executes various control processes in accordance with the operation input provided by the receptionist SP or the like. Examples of the input device 65 include a keyboard, a mouse, and a microphone in a case of performing a voice operation. The camera 64 included in the receptionist apparatus 60 may also correspond to the input device. In this case, the receptionist SP provides the operation input (gesture input) using a gesture such as moving a hand in front of the camera 64.

The receptionist apparatus 60 includes a display device 66. The display device 66 may be incorporated in the receptionist apparatus 60. The display device 66 may be connected to the receptionist apparatus 60 in a wireless or wired manner. The display device 66 displays images such as a still picture and a motion picture. The display device 66 displays a shape of the user who purchases the product or receives provision of the service. The display device 66 may display information indicating a content of the product purchased by the user or the content of the provided service received by the user.

Besides, the receptionist apparatus 60 may include another output device such as a speaker. The other output device outputs information related to the user who uses the goods sales tent or the like. For example, the information related to the user includes whether or not to purchase the product, and a voice of the user receiving provision of the service. The other output device may output voice information indicating the product purchased by the user or the content of the provided service received by the user. The other output device is not limited to a voice output device and may output other types of information such as fragrance information, taste information, and tactile information.

FIG. 2 is a block diagram illustrating a configuration of the server according to at least one embodiment of the present disclosure. A server 10A that is an example of the configuration of the server 10 includes at least an object display unit 101, a representation control unit 102, and a permission acquisition information display unit 103. The processor included in the server 10A functionally implements the object display unit 101, the representation control unit 102, and the permission acquisition information display unit 103 by referring to the event provision program held (installed) in the storage device and executing the program.

The object display unit 101 has a function of displaying a first object that is a virtual object on the display device in a superimposed manner on the real space. The representation control unit 102 has a function of controlling a representation using one or more virtual objects including the first object. The permission acquisition information display unit 103 has a function of displaying information (permission acquisition information) for causing the user to acquire a predetermined permission for a product or a service related to the object, the event, or the representation on the display device.

Next, a program execution process in the first embodiment of the present disclosure will be described. FIG. 3 is a flowchart illustrating an example of an event provision process according to at least one embodiment of the present disclosure.

The object display unit 101 displays the first object that is a virtual object on the display device in a superimposed manner on the real space (St11). The representation control unit 102 controls the representation using one or more virtual objects including the first object (St12). The permission acquisition information display unit 103 displays information (permission acquisition information) for causing the user to acquire the predetermined permission for the product or the service related to the object, the event, or the representation on the display device (St13).

The virtual object means an object that may be output in a virtual space that is not the real space. For example, a virtual chair or car represented by 3D modeling data or the like obtained by scanning a shape of an object such as a chair or a car in the real space corresponds to the virtual object here. In addition, a representation of an animate object such as a person, an animal, a plant, or a monster using 3D modeling data corresponds to the virtual object. The virtual object may be a virtual representation of a fictional target such as a fairy or a dragon. Dimensions of data for representing the virtual object are not limited to three dimensions. For example, a representation of the target using 2D data also corresponds to the virtual object here.

The real space means a space in a real world. The virtual space augmented from the real space means a virtual space (AR space) that can be output in a superimposed manner on the real space.

Displaying the virtual object on the display device means outputting display data for displaying the virtual object to an apparatus (for example, the user terminal 20) including the display device or to the display device. Displaying the virtual object on the display device may mean outputting an instruction for displaying the virtual object to an apparatus (for example, the user terminal 20 capable of generating or storing the display data) already having the display data or to the display device.

For example, the representation means external presentation of any information to a recipient, such as singing, dancing, acting, reciting a poem, playing a musical instrument, delivering a lecture, running, jumping, or crying. Controlling the representation using the virtual object may include controlling an action of the object, such as causing the object to sing a song, dance, act, recite a poem, play a musical instrument, deliver a lecture, run, jump, or cry. In addition, for example, controlling the representation using the virtual object may be transmitting any information to the recipient through one or more virtual objects, such as representing a mark of the five rings of the Olympics by causing five virtual cars to run as if drawing circles.

For example, the event means a place at which information is externally presented to the recipient, such as a live music event, a theatrical play event, or a seminar event.

The product means an article of a transaction target. The service means provision of any benefit from a certain entity to another entity. Any interpretation may be employed as to whether to interpret the virtual object that is actually data as the product or as a target related to provision of the service.

As the predetermined permission for the product or the service related to the object, the event, or the representation (hereinafter, simply referred to as the predetermined permission), for example, in a case where the product is an actual object in the real space, a permission to possess the actual object, a permission to receive a lease, and a permission to use in the real space correspond to the predetermined permission. In a case where the product is data, a permission to acquire the data, a permission to copy, a permission to modify, a permission to use, and the like correspond to the predetermined permission. For the service, a permission to receive the service and the like correspond to the predetermined permission.

As non-restrictive illustration, specific examples of the predetermined permission are as follows.
A permission to purchase or receive a lease of an actual article (for example, a figure) resembling a virtual character appearing in an event.
A permission to purchase or receive a lease of an actual article of clothes worn by a virtual character appearing in an event.
A permission to purchase or receive a lease of an actual article of a possession such as a guitar possessed by a virtual character appearing in an event.
A permission to purchase or receive a lease of an actual article corresponding to a stage apparatus (includes both of a virtual stage apparatus and a stage apparatus in the real space) appearing in an event.
A permission to acquire or use data indicating a virtual character appearing in an event, clothes worn by the character, or a virtual object possessed by the character.
A permission to add a sound effect to an actual article or a virtual object appearing in an event. For example, an engine sound of a virtual car changes.
A permission to purchase or receive a lease of an actual article related to an event, such as an official T-shirt or an official towel of the event.
A permission to purchase or receive a lease of a physical medium such as a CD or a DVD on which a song used in an event is recorded.
A permission to purchase or receive a lease of a physical medium such as a CD or a DVD on which a song related to an event or a representation (for example, a song provided by another artist belonging to the same agency as an event participant or another song included in a compilation album including songs used in the event) is recorded.
A permission to play back data in which the song is recorded by downloading or streaming the data.
A permission to purchase or receive a lease of a product related to a target that appears in an event or is included in a representation, such as receiving a delivery of green pepper in a case where an event participant speaks “green pepper”.
A permission to use data indicating the various targets in a video game, a game accompanying display in AR, or the like.
A permission to cause the various targets to appear in other media (an animation, a comic book, a game, and the like) related to an event.

These are merely an example, and the predetermined permission may be a permission other than the above.

For example, information (permission acquisition information) for causing the user to acquire the predetermined permission refers to information with which the user can express an intention to acquire the permission in a case where the user receives presentation of the information, such as information for displaying a purchase button for a permission to purchase an article.

Displaying the permission acquisition information on the display device means outputting display data for displaying the permission acquisition information to the apparatus (for example, the user terminal 20) including the display device or to the display device. Displaying the permission acquisition information on the display device may mean outputting an instruction for displaying the permission acquisition information to the apparatus (for example, the user terminal 20 capable of generating or storing the display data) already having the display data or to the display device.

As an aspect of the first embodiment, an event using augmented reality can be held, and goods sales and service provision can be performed in the event.

### Second Embodiment

A summary of a second embodiment of the present disclosure will be described. Hereinafter, an event provision program executed in a server will be illustratively described as the second embodiment. The server may be the server 10 included in the event provision system 100 illustrated in FIG. 1.

FIG. 4 is a block diagram illustrating a configuration of the server according to at least one embodiment of the present disclosure. A server 10B that is an example of the configuration of the server 10 includes at least the object display unit 101, the representation control unit 102, and a permission acquisition information display unit 103B. The processor included in the server 10B functionally implements the object display unit 101, the representation control unit 102, and the permission acquisition information display unit 103B by referring to the event provision program held (installed) in the storage device and executing the program.

The object display unit 101 has a function of displaying the first object that is a virtual object on the display device in a superimposed manner on the real space. The representation control unit 102 has a function of controlling the representation using one or more virtual objects including the first object.

The permission acquisition information display unit 103B has a function of displaying the permission acquisition information on the display device in a case where input operation information provided by the user with respect to product and other information that is information indicating the product or the service displayed on the display device is acquired.

Next, a program execution process in the second embodiment of the present disclosure will be described. FIG. 5 is a flowchart illustrating an example of an event provision process according to at least one embodiment of the present disclosure.

The object display unit 101 displays the first object that is a virtual object on the display device in a superimposed manner on the real space (St21). The representation control unit 102 controls the representation using one or more virtual objects including the first object (St22).

The permission acquisition information display unit 103B acquires the input operation information provided by the user with respect to the product and other information that is information indicating the product or the service displayed on the display device (St23). In a case where the input operation information is acquired, the permission acquisition information display unit 103B displays information (permission acquisition information) for causing the user to acquire the predetermined permission for the product or the service related to the object, the event, or the representation on the display device (St24).

Meanings of each term related to steps St21 and St22 and the permission acquisition information are the same as in the first embodiment and thus, will not be described.

The input operation information provided by the user means operation information input by the user. For example, information input by tapping or swiping a predetermined region of a touch panel display included in the user terminal 20 or inputting a voice corresponds to the input operation information. In addition, information input by inputting a gesture by the user using the AR glasses corresponds to the input operation information. Besides, information input by the user through various input devices such as a keyboard and a mouse corresponds to the input operation information.

The product and other information means information indicating the product or the service. For example, in a case where a T-shirt is a product of a purchase target, image information indicating the T-shirt displayed by the display device, icon image information indicating the T-shirt, and the like correspond to the product and other information. For a service for enabling a predetermined song to be played back by streaming, character string information, icon image information, and the like indicating a title of the song correspond to the product and other information. The product and other information may be displayed in AR. Displaying in AR means displaying the target in a superimposed manner on the real space or the like. Clothes worn by a virtual character object (includes a virtual human) displayed on the display device, the character (product is a 1/N size figure or the like), goods on which a team logo is drawn and that is worn by a professional player in a competition of a multi-to-multi battle royal game, a gaming PC used in the competition by the professional player, and the like may be displayed in AR as the product and other information. Accessories and the like that are worn by a person in the real space captured on the display device and are displayed in AR correspond to the product and other information.

The product and other information may be displayed in an aspect other than the display in AR. For example, an actual article such as a stage tool placed in an event venue in the real space may be captured on the display device such as the touch panel display of the smartphone or the AR glasses. The actual article captured on the display device may correspond to the product and other information indicating a related product (for example, a miniature toy of the stage apparatus). For example, the user can express an intention to purchase the related product by tapping a region in which the actual article is captured on the touch panel display. In order to implement this, the server 10B or the user terminal 20 may provide a function of setting the region of the actual article captured on the display device as an inputtable region so that the user can provide an input by selecting the region in which the actual article captured on the display device is present.

As an aspect of the second embodiment, for example, in a case where the user expresses an intention to acquire the permission to purchase the product, the permission acquisition information can be displayed. Accordingly, a user not having an intention to acquire the permission can focus on participating in the event.

### Third Embodiment

A summary of a third embodiment of the present disclosure will be described. Hereinafter, an event provision program executed in a server will be illustratively described as the third embodiment. The server may be the server 10 included in the event provision system 100 illustrated in FIG. 1.

FIG. 6 is a block diagram illustrating a configuration of the server according to at least one embodiment of the present disclosure. A server 10C that is an example of the configuration of the server 10 includes at least the object display unit 101, the representation control unit 102, and a permission acquisition information display unit 103C. The processor included in the server 10C functionally implements the object display unit 101, the representation control unit 102, and the permission acquisition information display unit 103C by referring to the event provision program held (installed) in the storage device and executing the program.

The object display unit 101 has a function of displaying the first object that is a virtual object on the display device in a superimposed manner on the real space. The representation control unit 102 has a function of controlling the representation using one or more virtual objects including the first object.

The permission acquisition information display unit 103C has a function of displaying information (permission acquisition information) for causing the user to acquire the predetermined permission for the product or the service related to the object, the event, or the representation on the display device. The permission acquisition information display unit 103C displays the permission acquisition information in a second region different from a first region in which the first object is displayed by the display device.

Next, a program execution process in the third embodiment of the present disclosure will be described. FIG. 7 is a flowchart illustrating an example of an event provision process according to at least one embodiment of the present disclosure.

The object display unit 101 displays the first object that is a virtual object on the display device in a superimposed manner on the real space (St31). The representation control unit 102 controls the representation using one or more virtual objects including the first object (St32). The permission acquisition information display unit 103C displays the permission acquisition information in the second region different from the first region in which the first object is displayed on the display device (St33).

Each term related to steps St31 to St33 is the same as in the first embodiment or the second embodiment and thus, will not be described.

As an aspect of the third embodiment, by separating the first region used in the event and the second region in which purchase or the like of the product is performed, display for performing purchase or the like of the product does not hinder participation of the user in the event.

### Fourth Embodiment

A summary of a fourth embodiment of the present disclosure will be described. Hereinafter, an event provision program executed in a server will be illustratively described as the fourth embodiment. The server may be the server 10 included in the event provision system 100 illustrated in FIG. 1.

FIG. 8 is a block diagram illustrating a configuration of the server according to at least one embodiment of the present disclosure. A server 10D that is an example of the configuration of the server 10 includes at least the object display unit 101, a representation control unit 102D, and the permission acquisition information display unit 103. The processor included in the server 10D functionally implements the object display unit 101, the representation control unit 102D, and the permission acquisition information display unit 103 by referring to the event provision program held (installed) in the storage device and executing the program.

The object display unit 101 has a function of displaying the first object that is a virtual object on the display device in a superimposed manner on the real space. The representation control unit 102D has a function of controlling the representation using one or more virtual objects including the first object depending on whether or not the permission is acquired. The permission acquisition information display unit 103 has a function of displaying information (permission acquisition information) for causing the user to acquire the predetermined permission for the product or the service related to the object, the event, or the representation on the display device.

Next, a program execution process in the fourth embodiment of the present disclosure will be described. FIG. 9 is a flowchart illustrating an example of an event provision process according to at least one embodiment of the present disclosure.

The object display unit 101 displays the first object that is a virtual object on the display device in a superimposed manner on the real space (St41). The representation control unit 102D controls the representation using one or more virtual objects including the first object depending on whether or not the permission is acquired (St42). The permission acquisition information display unit 103 has a function of displaying information (permission acquisition information) for causing the user to acquire the predetermined permission for the product or the service related to the object, the event, or the representation on the display device.

Controlling the representation using one or more virtual objects including the first object depending on whether or not the permission is acquired means, for example, controlling the representation such that at least a part of the representation is different between the user who acquires the permission, and the user who does not acquire the permission.

Each of the other terms related to steps St41 to St43 is the same as in the first embodiment to the third embodiment and thus, will not be described.

As an aspect of the fourth embodiment, different staging can be performed in the event depending on whether or not the user acquires the permission. Accordingly, even in a case where the event is basically the same, each user can experience different events, and the event can be individualized.

### Fifth Embodiment

A summary of a fifth embodiment of the present disclosure will be described. Hereinafter, an event provision system will be illustratively described as the fifth embodiment.

FIG. 10 is a diagram illustrating an example of a configuration of an event provision system according to at least one embodiment of the present disclosure. An event provision system 100A includes the event provision process server 10 (server 10) and the user terminal 20 used by a user of the event provision system 100A. Each of the user terminals 20A, 20B, and 20C is an example of the user terminal 20. The configuration of the event provision system 100A is not limited thereto. For example, the event provision system 100A may have a configuration in which a plurality of users use a single user terminal. The event provision system 100A may include a plurality of servers. For example, the event provision system 100A may further include the other server 40.

The event provision system 100A may further include the receptionist apparatus 60. For example, a receptionist SP who receives the user visiting a goods sales tent (refer to FIG. 21), described later, uses the receptionist apparatus 60. Specific examples of the receptionist apparatus 60 include a server apparatus, a client apparatus, the user terminal, and the like.

Each of the server 10, the user terminal 20, the other server 40, and the receptionist apparatus 60 is communicably connected to the communication network 30 such as the Internet. Connection among the server 10, the user terminal 20, the other server 40, and the receptionist apparatus 60 through the communication network 30 may be wired connection or wireless connection. For example, a plurality of the user terminals 20 may be connected to the communication network 30 by performing data communication with the base station managed by the communication service provider using the wireless communication line.

The event provision system 100A, by including the server 10 and the user terminal 20, implements various functions for executing various processes in accordance with the operation of the user.

The server 10 includes the processor 11, the memory 12, and the storage device 13. For example, the processor 11 is a central processing device such as a central processing unit (CPU) that performs various calculations and controls. In addition, in a case where the server 10 includes a graphics processing unit (GPU), the GPU may perform a part of the various calculations and controls. The server 10 executes various information processes by the processor 11 using data read into the memory 12 and stores obtained process results in the storage device 13 as needed.

The storage device 13 has a function as a storage medium storing various information. A configuration of the storage device 13 is not particularly limited but is preferably a configuration capable of storing all of various information necessary for controls performed in the event provision system 100A from a viewpoint of reducing the process load exerted on the user terminal 20. Such examples include an HDD and an SSD. However, the storage device storing various information may have a storage region in an accessible state from the server 10 and, for example, may be configured to have a dedicated storage region outside the server 10. The server 10 is managed by a manager or the like of the event provision system 100A and has various functions for providing information related to various processes to the plurality of user terminals 20. The server 10 is configured with an information processing apparatus such as a game server that can render AR display data.

The user terminal 20 is configured with a communication terminal that can provide an information service accompanying AR display to the user. Examples of the communication terminal include, for example, a mobile phone terminal 20A such as a smartphone and AR glasses 20B and 20C. The communication terminal may be a stationary game apparatus, a portable game apparatus, a personal computer, a gaming PC, or a so-called wearable device, or a combination of a plurality of the communication terminals. The configuration of the user terminal that may be included in the event provision system 100A is not limited thereto and may be a configuration in which the user may visually recognize the display in AR.

The user terminal 20 includes the processor 21, the memory 22, and the storage device 23. For example, the processor 21 is a central processing device such as a central processing unit (CPU) that performs various calculations and controls. In addition, in a case where the user terminal 20 includes a graphics processing unit (GPU), the GPU may perform a part of the various calculations and controls. The user terminal 20 executes various information processes by the processor 21 using data read into the memory 22 and stores obtained process results in the storage device 23 as needed. The storage device 23 has a function as a storage medium storing various information.

The user terminal 20 is connected to the communication network 30 and includes hardware and software for executing various processes by communicating with the server 10, the other server 40, or the receptionist apparatus 60. Each of the plurality of user terminals 20 may be configured to be capable of directly communicating with each other without the server 10, the other server 40, or the receptionist apparatus 60.

The user terminal 20 may incorporate a display device. The display device may be connected to the user terminal 20 in a wireless or wired manner. The display device displays images such as a still picture and a motion picture. The display device may display a game screen. The display device may display a shape of the receptionist SP based on data acquired directly from the receptionist apparatus 60 through the communication network 30 or further via the server 10 or the like. In addition, the display device can perform augmented reality (AR) display superimposed on a real space. Examples of the display device include a hologram display device that can perform hologram display, and a projection device that projects images (including the game screen) to a screen or the like. In the example in FIG. 10, the touch panel screen included in the mobile phone terminal 20A, the AR displays included in the AR glasses 20B and 20C, and the like correspond to the display device.

The user terminal 20 may incorporate an input device. In addition, the input device may be connected to the user terminal 20 in a wireless or wired manner. The input device receives an operation input provided by the user. The processor included in the server 10 or the processor included in the user terminal 20 executes various control processes in accordance with the operation input provided by the user. Examples of the input device include the touch panel screen included in the mobile phone terminal 20A, the controller CTR that is connected to the AR glasses 20B in a wireless or wired manner, and the like. In addition, the camera included in the user terminal 20 may correspond to the input device. The user provides the operation input (gesture input) by a gesture such as moving a hand in front of the camera.

Besides, the user terminal 20 may include another output device such as a speaker. The other output device outputs various information to the user. For example, the output information includes the voice of the receptionist SP. The other output device may output voice information indicating the product purchased by the user or the content of the provided service received by the user. The other output device is not limited to a voice output device and may output other types of information. Besides, the other output device using haptic technology may output tactile information.

The other server 40 includes the processor 41, the memory 42, and the storage device 43. For example, the processor 41 is a central processing device such as a central processing unit (CPU) that performs various calculations and controls. In addition, in a case where the other server 40 includes a graphics processing unit (GPU), the GPU may perform a part of the various calculations and controls. The other server 40 executes various information processes by the processor 41 using data read into the memory 42 and stores obtained process results in the storage device 43 as needed.

The storage device 43 has a function as a storage medium storing various information. The configuration of the storage device 43 is not limited thereto. The storage device storing various information may have a storage region in an accessible state from the other server 40 and, for example, may be configured to have a dedicated storage region outside the other server 40. The other server 40 may be managed by the manager or the like of the event provision system 100A or may be managed by other persons. The other server 40 has various functions for providing information related to various processes to the plurality of user terminals 20. For example, the other server 40 may be a server that manages manufacturing and delivery of the actual article. The other server 40 may be a server that manages distribution of the motion picture related to the live event.

The receptionist apparatus 60 includes the processor 61, the memory 62, and the storage device 63. For example, the processor 61 is a central processing device such as a central processing unit (CPU) that performs various calculations and controls. In addition, in a case where the receptionist apparatus 60 includes a graphics processing unit (GPU), the GPU may perform a part of the various calculations and controls. The receptionist apparatus 60 executes various information processes by the processor 61 using data read into the memory 62 and stores obtained process results in the storage device 63 as needed. The storage device 63 has a function as a storage medium storing various information.

The receptionist apparatus 60 is connected to the communication network 30 and includes hardware and software for executing various processes by communicating with the server 10, the user terminal 20, or the other server 40.

The receptionist apparatus 60 includes the camera 64 and the input device 65. For example, the camera 64 images the receptionist SP who is a salesperson of the goods sales tent (refer to FIG. 21). In a case where the user purchases the product or the like, captured image data in which the shape of the receptionist SP is captured is used for receiving the user by the receptionist SP in the cashier region described later. The input device 65 receives the operation input provided by the receptionist SP or the like. The processor 61 included in the receptionist apparatus 60 executes various control processes in accordance with the operation input provided by the receptionist SP or the like. Examples of the input device 65 include a keyboard, a mouse, and a microphone in a case of performing a voice operation. The camera 64 included in the receptionist apparatus 60 may also correspond to the input device. In this case, the receptionist SP provides the operation input (gesture input) using a gesture such as moving a hand in front of the camera 64.

The receptionist apparatus 60 includes the display device 66. The display device 66 may be incorporated in the receptionist apparatus 60. The display device 66 may be connected to the receptionist apparatus 60 in a wireless or wired manner. The display device 66 displays images such as a still picture and a motion picture. The display device 66 displays the shape of the user who purchases the product or receives provision of the service. The display device 66 may display information indicating the content of the product purchased by the user or the content of the provided service received by the user.

Besides, the receptionist apparatus 60 may include another output device such as a speaker. The other output device outputs information related to the user who uses the goods sales tent or the like. For example, the information related to the user includes whether or not to purchase the product, and the voice of the user receiving provision of the service. The other output device may output voice information indicating the product purchased by the user or the content of the provided service received by the user. The other output device is not limited to a voice output device and may output other types of information such as fragrance information, taste information, and tactile information.

FIG. 11 is a block diagram illustrating a configuration of the event provision system according to at least one embodiment of the present disclosure. The event provision system 100A includes at least an object display unit 501, a representation control unit 502, and a permission acquisition information display unit 503. One or more processors included in the event provision system 100A functionally implement the object display unit 501, the representation control unit 502, and the permission acquisition information display unit 503 by referring to the event provision program held (installed) in one or more storage devices included in the event provision system 100A and executing the program.

The object display unit 501 has a function of displaying the first object that is a virtual object on the display device in a superimposed manner on the real space. The representation control unit 502 has a function of controlling the representation using one or more virtual objects including the first object. The permission acquisition information display unit 503 has a function of displaying information (permission acquisition information) for causing the user to acquire the predetermined permission for the product or the service related to the object, the event, or the representation on the display device.

Next, a program execution process in the fifth embodiment of the present disclosure will be described. FIG. 12 is a flowchart illustrating an example of an event provision process according to at least one embodiment of the present disclosure.

The object display unit 501 displays the first object that is a virtual object on the display device in a superimposed manner on the real space (St51). The representation control unit 502 controls the representation using one or more virtual objects including the first object (St52). The permission acquisition information display unit 503 displays information (permission acquisition information) for causing the user to acquire the predetermined permission for the product or the service related to the object, the event, or the representation on the display device (St53).

The virtual object means an object that may be output in the virtual space that is not the real space. For example, a virtual chair or car represented by 3D modeling data or the like obtained by scanning a shape of an object such as a chair or a car in the real space corresponds to the virtual object here. In addition, a representation of an animate object such as a person, an animal, a plant, or a monster using 3D modeling data corresponds to the virtual object. The virtual object may be a virtual representation of a fictional target such as a fairy or a dragon. Dimensions of data for representing the virtual object are not limited to three dimensions. For example, a representation of the target using 2D data also corresponds to the virtual object here.

The real space means a space in the real world. The virtual space augmented from the real space means a virtual space (AR space) that can be output in a superimposed manner on the real space.

Displaying the virtual object on the display device means outputting display data for displaying the virtual object to the apparatus (for example, the user terminal 20) including the display device or to the display device. Displaying the virtual object on the display device may mean outputting an instruction for displaying the virtual object to the apparatus (for example, the user terminal 20 capable of generating or storing the display data) already having the display data or to the display device.

For example, the representation means external presentation of any information to a recipient, such as singing, dancing, acting, reciting a poem, playing a musical instrument, delivering a lecture, running, jumping, or crying. Controlling the representation using the virtual object may include controlling an action of the object, such as causing the object to sing a song, dance, act, recite a poem, play a musical instrument, deliver a lecture, run, jump, or cry. In addition, for example, controlling the representation using the virtual object may be transmitting any information to the recipient through one or more virtual objects, such as representing a mark of the five rings of the Olympics by causing five virtual cars to run as if drawing circles.

For example, the event means a place at which information is externally presented to the recipient, such as a live music event, a theatrical play event, or a seminar event.

The product means an article of the transaction target. The service means provision of any benefit from a certain entity to another entity. Any interpretation may be employed as to whether to interpret the virtual object as the product or as the target related to provision of the service.

As the predetermined permission for the product or the service related to the object, the event, or the representation (hereinafter, simply referred to as the predetermined permission), for example, in a case where the product is an actual object in the real space, a permission to possess the actual object, a permission to receive a lease, and a permission to use in the real space correspond to the predetermined permission. In a case where the product is data, a permission to acquire the data, a permission to copy, a permission to modify, a permission to use, and the like correspond to the predetermined permission. For the service, a permission to receive the service and the like correspond to the predetermined permission.

As non-restrictive illustration, specific examples of the predetermined permission are as follows.
A permission to purchase or receive a lease of an actual article (for example, a figure) resembling a virtual character appearing in an event.
A permission to purchase or receive a lease of an actual article of clothes worn by a virtual character appearing in an event.
A permission to purchase or receive a lease of an actual article of a possession such as a guitar possessed by a virtual character appearing in an event.
A permission to purchase or receive a lease of an actual article corresponding to a stage apparatus (includes both of a virtual stage apparatus and a stage apparatus in the real space) appearing in an event.
A permission to acquire or use data indicating a virtual character appearing in an event, clothes worn by the character, or a virtual object possessed by the character.
A permission to add a sound effect to an actual article or a virtual object appearing in an event. For example, an engine sound of a virtual car changes.
A permission to purchase or receive a lease of an actual article related to an event, such as an official T-shirt or an official towel of the event.
A permission to purchase or receive a lease of a physical medium such as a CD or a DVD on which a song used in an event is recorded.
A permission to purchase or receive a lease of a physical medium such as a CD or a DVD on which a song related to an event or a representation (for example, a song provided by another artist belonging to the same agency as an event participant or another song included in a compilation album including songs used in the event) is recorded.
A permission to play back data in which the song is recorded by downloading or streaming the data.
A permission to purchase or receive a lease of a product related to a target that appears in an event or is included in a representation, such as receiving a delivery of green pepper in a case where an event participant speaks “green pepper”.
A permission to use data indicating the various targets in a video game, a game accompanying display in AR, or the like.
A permission to cause the various targets to appear in other media (an animation, a comic book, a game, and the like) related to an event.

These are merely an example, and the predetermined permission may be a permission other than the above.

For example, information (permission acquisition information) for causing the user to acquire the predetermined permission refers to information with which the user can express an intention to acquire the permission in a case where the user receives presentation of the information, such as information for displaying a purchase button for a permission to purchase an article.

Displaying the permission acquisition information on the display device means outputting display data for displaying the permission acquisition information to the apparatus (for example, the user terminal 20) including the display device or to the display device. Displaying the permission acquisition information on the display device may mean outputting an instruction for displaying the permission acquisition information to the apparatus (for example, the user terminal 20 capable of generating or storing the display data) already having the display data or to the display device.

As an aspect of the fifth embodiment, an event using augmented reality can be held, and goods sales and service provision can be performed in the event.

### Sixth Embodiment

A summary of a sixth embodiment of the present disclosure will be described. Hereinafter, an event provision program executed in a user terminal will be illustratively described as the sixth embodiment. A user terminal 20Z may be any of the plurality of user terminals 20 and 20A to 20C illustrated in FIG. 1 or FIG. 10.

FIG. 13 is a block diagram illustrating a configuration of the user terminal according to at least one embodiment of the present disclosure. The user terminal 20Z that is an example of the configuration of the user terminal 20 includes at least an object display unit 201, a representation control unit 202, and a permission acquisition information display unit 203. The processor included in the user terminal 20Z functionally implements the object display unit 201, the representation control unit 202, and the permission acquisition information display unit 203 by referring to the event provision program held (installed) in the storage device and executing the program.

The object display unit 201 has a function of displaying the first object that is a virtual object on the display device in a superimposed manner on the real space. The representation control unit 202 has a function of controlling the representation using one or more virtual objects including the first object. The permission acquisition information display unit 203 has a function of displaying information (permission acquisition information) for causing the user to acquire the predetermined permission for the product or the service related to the object, the event, or the representation on the display device.

Next, a program execution process in the sixth embodiment of the present disclosure will be described. FIG. 14 is a flowchart illustrating an example of an event provision process according to at least one embodiment of the present disclosure.

The object display unit 201 displays the first object that is a virtual object on the display device in a superimposed manner on the real space (St61). The representation control unit 202 controls the representation using one or more virtual objects including the first object (St62). The permission acquisition information display unit 203 displays information (permission acquisition information) for causing the user to acquire the predetermined permission for the product or the service related to the object, the event, or the representation on the display device (St63).

The virtual object means an object that may be output in the virtual space that is not the real space. For example, a virtual chair or car represented by 3D modeling data or the like obtained by scanning a shape of an object such as a chair or a car in the real space corresponds to the virtual object here. In addition, a representation of an animate object such as a person, an animal, a plant, or a monster using 3D modeling data corresponds to the virtual object. The virtual object may be a virtual representation of a fictional target such as a fairy or a dragon. Dimensions of data for representing the virtual object are not limited to three dimensions. For example, a representation of the target using 2D data also corresponds to the virtual object here.

The real space means a space in the real world. The virtual space augmented from the real space means a virtual space (AR space) that can be output in a superimposed manner on the real space.

Displaying the virtual object on the display device means outputting display data for displaying the virtual object to an apparatus (for example, the user terminal 20) including the display device or to the display device. Displaying the virtual object on the display device may mean outputting an instruction for displaying the virtual object to an apparatus (for example, the user terminal 20 capable of generating or storing the display data) already having the display data or to the display device.

For example, the representation means external presentation of any information to a recipient, such as singing, dancing, acting, reciting a poem, playing a musical instrument, delivering a lecture, running, jumping, or crying. Controlling the representation using the virtual object may include controlling an action of the object, such as causing the object to sing a song, dance, act, recite a poem, play a musical instrument, deliver a lecture, run, jump, or cry. In addition, for example, controlling the representation using the virtual object may be transmitting any information to the recipient through one or more virtual objects, such as representing a mark of the five rings of the Olympics by causing five virtual cars to run as if drawing circles.

For example, the event means a place at which information is externally presented to the recipient, such as a live music event, a theatrical play event, or a seminar event.

The product means an article of the transaction target. The service means provision of any benefit from a certain entity to another entity. Any interpretation may be employed as to whether to interpret the virtual object as the product or as the target related to provision of the service.

As the predetermined permission for the product or the service related to the object, the event, or the representation (hereinafter, simply referred to as the predetermined permission), for example, in a case where the product is an actual object in the real space, a permission to possess the actual object, a permission to receive a lease, and a permission to use in the real space correspond to the predetermined permission. In a case where the product is data, a permission to acquire the data, a permission to copy, a permission to modify, a permission to use, and the like correspond to the predetermined permission. For the service, a permission to receive the service and the like correspond to the predetermined permission.

As non-restrictive illustration, specific examples of the predetermined permission are as follows.
A permission to purchase or receive a lease of an actual article (for example, a figure) resembling a virtual character appearing in an event.
A permission to purchase or receive a lease of an actual article of clothes worn by a virtual character appearing in an event.
A permission to purchase or receive a lease of an actual article of a possession such as a guitar possessed by a virtual character appearing in an event.
A permission to purchase or receive a lease of an actual article corresponding to a stage apparatus (includes both of a virtual stage apparatus and a stage apparatus in the real space) appearing in an event.
A permission to acquire or use data indicating a virtual character appearing in an event, clothes worn by the character, or a virtual object possessed by the character.
A permission to add a sound effect to an actual article or a virtual object appearing in an event. For example, an engine sound of a virtual car changes.
A permission to purchase or receive a lease of an actual article related to an event, such as an official T-shirt or an official towel of the event.
A permission to purchase or receive a lease of a physical medium such as a CD or a DVD on which a song used in an event is recorded.
A permission to purchase or receive a lease of a physical medium such as a CD or a DVD on which a song related to an event or a representation (for example, a song provided by another artist belonging to the same agency as an event participant or another song included in a compilation album including songs used in the event) is recorded.
A permission to play back data in which the song is recorded by downloading or streaming the data.
A permission to purchase or receive a lease of a product related to a target that appears in an event or is included in a representation, such as receiving a delivery of green pepper in a case where an event participant speaks “green pepper”.
A permission to use data indicating the various targets in a video game, a game accompanying display in AR, or the like.
A permission to cause the various targets to appear in other media (an animation, a comic book, a game, and the like) related to an event.

These are merely an example, and the predetermined permission may be a permission other than the above.

For example, information (permission acquisition information) for causing the user to acquire the predetermined permission refers to information with which the user can express an intention to acquire the permission in a case where the user receives presentation of the information, such as information for displaying a purchase button for a permission to purchase an article.

Displaying the permission acquisition information on the display device means outputting display data for displaying the permission acquisition information to the apparatus (for example, the user terminal 20) including the display device or to the display device. Displaying the permission acquisition information on the display device may mean outputting an instruction for displaying the permission acquisition information to the apparatus (for example, the user terminal 20 capable of generating or storing the display data) already having the display data or to the display device.

As an aspect of the sixth embodiment, an event using augmented reality can be held, and goods sales and service provision can be performed in the event.

### Seventh Embodiment

A summary of a seventh embodiment of the present disclosure will be described. Hereinafter, an event provision program executed in a server will be illustratively described as the seventh embodiment.

FIG. 15 is a block diagram illustrating a configuration of the server according to at least one embodiment of the present disclosure. A server 10Z that is an example of the configuration of the server 10 includes the object display unit 101, the representation control unit 102, the permission acquisition information display unit 103, an augmented reality diorama display unit 104, and a recommendation information display unit 105. The processor included in the server 10Z functionally implements the object display unit 101, the representation control unit 102, the permission acquisition information display unit 103, the augmented reality diorama display unit 104, and the recommendation information display unit 105 by referring to the event provision program held (installed) in the storage device and executing the program.

The object display unit 101 has a function of displaying the first object that is a virtual object on the display device in a superimposed manner on the real space. The representation control unit 102 has a function of controlling the representation using one or more virtual objects including the first object. The permission acquisition information display unit 103 has a function of displaying information (permission acquisition information) for causing the user to acquire the predetermined permission for the product or the service related to the object, the event, or the representation on the display device.

The augmented reality diorama display unit 104 has a function of displaying an augmented reality diorama superimposed on the real space on the display device. The recommendation information display unit 105 has a function of displaying recommendation information indicating a product or a service for which acquisition of the permission by the user is recommended, on the display device in accordance with a content of the representation using one or more virtual objects including the first object, input information provided by the user, or predetermined accumulated information.

The virtual object means an object that may be output in the virtual space that is not the real space. For example, a virtual chair or car represented by 3D modeling data or the like obtained by scanning a shape of an object such as a chair or a car in the real space corresponds to the virtual object here. In addition, a representation of an animate object such as a person, an animal, a plant, or a monster using 3D modeling data corresponds to the virtual object. The virtual object may be a virtual representation of a fictional target such as a fairy or a dragon. Dimensions of data for representing the virtual object are not limited to three dimensions. For example, a representation of the target using 2D data also corresponds to the virtual object here.

The real space means a space in the real world. The virtual space augmented from the real space means a virtual space (AR space) that can be output in a superimposed manner on the real space.

Displaying the virtual object on the display device means outputting display data for displaying the virtual object to the apparatus (for example, the user terminal 20) including the display device or to the display device. Displaying the virtual object on the display device may mean outputting an instruction for displaying the virtual object to the apparatus (for example, the user terminal 20 capable of generating or storing the display data) already having the display data or to the display device.

For example, the representation means external presentation of any information to a recipient, such as singing, dancing, acting, reciting a poem, playing a musical instrument, delivering a lecture, running, jumping, or crying. Controlling the representation using the virtual object may include controlling an action of the object, such as causing the object to sing a song, dance, act, recite a poem, play a musical instrument, deliver a lecture, run, jump, or cry. In addition, for example, controlling the representation using the virtual object may be transmitting any information to the recipient through one or more virtual objects, such as representing a mark of the five rings of the Olympics by causing five virtual cars to run as if drawing circles.

For example, the event means a place at which information is externally presented to the recipient, such as a live music event, a theatrical play event, or a seminar event.

The product means an article of the transaction target. The service means provision of any benefit from a certain entity to another entity. Any interpretation may be employed as to whether to interpret the virtual object as the product or as the target related to provision of the service.

As the predetermined permission for the product or the service related to the object, the event, or the representation (hereinafter, simply referred to as the predetermined permission), for example, in a case where the product is an actual object in the real space, a permission to possess the actual object, a permission to receive a lease, and a permission to use in the real space correspond to the predetermined permission. In a case where the product is data, a permission to acquire the data, a permission to copy, a permission to modify, a permission to use, and the like correspond to the predetermined permission. For the service, a permission to receive the service and the like correspond to the predetermined permission.

As non-restrictive illustration, specific examples of the predetermined permission are as follows.
A permission to purchase or receive a lease of an actual article (for example, a figure) resembling a virtual character appearing in an event.
A permission to purchase or receive a lease of an actual article of clothes worn by a virtual character appearing in an event.
A permission to purchase or receive a lease of an actual article of a possession such as a guitar possessed by a virtual character appearing in an event.
A permission to purchase or receive a lease of an actual article corresponding to a stage apparatus (includes both of a virtual stage apparatus and a stage apparatus in the real space) appearing in an event.
A permission to acquire or use data indicating a virtual character appearing in an event, clothes worn by the character, or a virtual object possessed by the character.
A permission to add a sound effect to an actual article or a virtual object appearing in an event. For example, an engine sound of a virtual car changes.
A permission to purchase or receive a lease of an actual article related to an event, such as an official T-shirt or an official towel of the event.
A permission to purchase or receive a lease of a physical medium such as a CD or a DVD on which a song used in an event is recorded.
A permission to purchase or receive a lease of a physical medium such as a CD or a DVD on which a song related to an event or a representation (for example, a song provided by another artist belonging to the same agency as an event participant or another song included in a compilation album including songs used in the event) is recorded.
A permission to play back data in which the song is recorded by downloading or streaming the data.
A permission to purchase or receive a lease of a product related to a target that appears in an event or is included in a representation, such as receiving a delivery of green pepper in a case where an event participant speaks “green pepper”.
A permission to use data indicating the various targets in a video game, a game accompanying display in AR, or the like.
A permission to cause the various targets to appear in other media (an animation, a comic book, a game, and the like) related to an event.

These are merely an example, and the predetermined permission may be a permission other than the above.

For example, information (permission acquisition information) for causing the user to acquire the predetermined permission refers to information with which the user can express an intention to acquire the permission in a case where the user receives presentation of the information, such as information for displaying a purchase button for a permission to purchase an article.

Displaying the permission acquisition information on the display device means outputting display data for displaying the permission acquisition information to the apparatus (for example, the user terminal 20) including the display device or to the display device. Displaying the permission acquisition information on the display device may mean outputting an instruction for displaying the permission acquisition information to the apparatus (for example, the user terminal 20 capable of generating or storing the display data) already having the display data or to the display device.

The input operation information provided by the user means operation information input by the user. For example, information input by tapping or swiping a predetermined region of a touch panel display included in the user terminal 20 or inputting a voice corresponds to the input operation information. In addition, information input by inputting a gesture by the user using the AR glasses corresponds to the input operation information. Besides, information input by the user through various input devices such as a keyboard and a mouse corresponds to the input operation information.

The product and other information means information indicating the product or the service. For example, in a case where a T-shirt is a product of the purchase target, image information indicating the T-shirt displayed by the display device, icon image information indicating the T-shirt, and the like correspond to the product and other information. For a service for enabling a predetermined song to be played back by streaming, character string information, icon image information, and the like indicating a title of the song correspond to the product and other information. The product and other information may be displayed in AR. Displaying in AR means displaying the target in a superimposed manner on the real space or the like. Clothes worn by a virtual character object (includes a virtual human) displayed on the display device, the character (product is a 1/N size figure or the like), goods on which a team logo is drawn and that is worn by a professional player in a competition of a multi-to-multi battle royal game, a gaming PC used in the competition by the professional player, and the like may be displayed in AR as the product and other information. Accessories and the like that are worn by a person in the real space captured on the display device and are displayed in AR correspond to the product and other information.

The product and other information may be displayed in an aspect other than the display in AR. For example, an actual article such as a stage tool placed in an event venue in the real space may be captured on the display device such as the touch panel display of the smartphone or the AR glasses. The actual article captured on the display device may correspond to the product and other information indicating a related product (for example, a miniature toy of the stage apparatus). For example, the user can express an intention to purchase the related product by tapping a region in which the actual article is captured on the touch panel display. In order to implement this, the server 10Z or the user terminal 20 may provide a function of setting the region of the actual article captured on the display device as an inputtable region so that the user can provide an input by selecting the region in which the actual article captured on the display device is present.

Controlling the representation using one or more virtual objects including the first object depending on whether or not the permission is acquired means, for example, controlling the representation such that at least a part of the representation is different between the user who acquires the permission, and the user who does not acquire the permission.

The augmented reality diorama means a virtual diorama output in a superimposed manner on the real space. Examples of the augmented reality diorama include a street, a road, a railway, a building, a group of buildings, a stadium of baseball, soccer, or the like, a shrine or a temple, a castle, a mountain, the sea, a river, a swamp, a grove, a forest, a field, a paddy field, an airport, an underground passage, a cave, and the like represented as 3D model data for the augmented reality (AR) display. The augmented reality diorama may not necessarily be based on a modern landscape that exists in the reality. Examples of the augmented reality diorama also include a medieval European streetscape or construction and a fictional streetscape or construction appearing in an animation, a comic book, or the like.

Displaying the augmented reality diorama on the display device means outputting display data for displaying the augmented reality diorama in a superimposed manner on the real space to an apparatus (for example, the user terminal 20) including the display device or to the display device. In addition, displaying the augmented reality diorama on the display device may mean outputting an instruction for displaying the augmented reality diorama in a superimposed manner on the real space to an apparatus (for example, the user terminal 20 capable of generating or storing the display data) already having the display data or to the display device.

The input information provided by the user means input information caused by the user. For example, information input through the user terminal 20 corresponds to the input information provided by the user. The server 10Z may acquire the input information from the user terminal 20 through the communication network 30.

In addition, input information that is separately acquired by the server 10Z without the user terminal 20 may be used as the input information provided by the user. For example, in a case where action history information about an action that is performed in the past in the augmented reality diorama or an augmented space corresponding to the event such as the live event by the user or the avatar associated with the user is acquired by the server 10Z as log data, the log data may correspond to the input information provided by the user. In addition, information that is related to the user and is acquired from an external system such as the other server 40 by the server 10Z corresponds to the input information provided by the user. For example, the input information provided by the user here may include purchase history information in a case where the user purchases a product using another product sales site, use history information in a case where the user uses transportation such as an electric train, contents data posted by the user using an SNS service, and text information indicating a speech made through the SNS service.

The accumulated information means information accumulated in a storage device accessible from a process entity (here, the server 10Z). For example, attribute information (an age, a preference, and the like) of each user, the purchase history information, and detailed information (a performance name, a performed date, a performed location, a performer, an organizer, a co-organizer, a used song, a name of a tied-up animation program, and the like) about the event stored in the storage device correspond to the accumulated information. The accumulated information may be information accumulated along with a progress of the event. For example, a total number of participants of the currently performed live event, how many persons are viewing which stage, impression information or evaluation information input through the user terminal 20 or the like with respect to the live event, and estimated value information indicating a degree of excitement of the live event correspond to the accumulated information. That is, the accumulated information includes various information not limited to information related to the individual user. The accumulated information may include various attribute information of the virtual object displayed in AR and various attribute information of the augmented reality diorama.

The recommendation information means information indicating the product or the service for which acquisition of the permission by the user is recommended. For example, title information of a CD on which a song sung by an artist in a live music event is recorded, and link information for accessing a site on which the CD can be purchased correspond to the recommendation information. In addition, for an event of a live stage theatrical play, for example, URL information of a site for acquiring a permission to play back, by streaming, a performance performed in the past by a theater company that organizes the theatrical play corresponds to the recommendation information. A type of recommendation information is not limited thereto.

Displaying the recommendation information on the display device means outputting display data for displaying the recommendation information to the apparatus (for example, the user terminal 20) including the display device or to the display device. Displaying the recommendation information on the display device may mean outputting an instruction for displaying the recommendation information to the apparatus (for example, the user terminal 20 capable of generating or storing the display data) already having the display data or to the display device.

Next, a program execution process in the seventh embodiment of the present disclosure will be described. FIG. 16 is a flowchart illustrating an example of an event provision process according to at least one embodiment of the present disclosure.

The augmented reality diorama display unit 104 displays the augmented reality diorama superimposed on the real space on the display device (St111). The object display unit 101 displays the first object that is a virtual object on the display device in a superimposed manner on the real space (St112). The representation control unit 102 controls the representation using one or more virtual objects including the first object (St113). The recommendation information display unit 105 displays the recommendation information indicating the product or the service for which acquisition of the permission by the user is recommended, on the display device in accordance with the content of the representation using one or more virtual objects including the first object, the input information provided by the user, or the predetermined accumulated information (St114). The permission acquisition information display unit 103 acquires the input operation information provided by the user with respect to the product and other information that is information indicating the product or the service displayed on the display device (St115). In a case where the input operation information is acquired, the permission acquisition information display unit 103 displays information (permission acquisition information) for causing the user to acquire the predetermined permission for the product or the service related to the object, the event, or the representation on the display device (St116).

At least step St111, step St114, and step St115 may not be provided.

FIG. 17 is a conceptual diagram illustrating a display example by the display device according to at least one embodiment of the present disclosure. In the example of the present embodiment, a display device DISP is the touch panel display included in the user terminal 20. However, as described above, the display device DISP may be incorporated in another apparatus such as the AR glasses or may be a display device connected to the other apparatus. A captured image captured by the camera (not illustrated) included in the user terminal 20 is displayed by the display device DISP. Thus, a television TV present in the real space is captured on the display device DISP. A first object OBJ1 that is a virtual object is displayed on the display device DISP in a superimposed manner on the real space (step St112). In addition, a second object OBJ2 that is a virtual object is displayed on the display device DISP in a superimposed manner on the real space. In the example of the present embodiment, the first object OBJ1 corresponds to an artist in a live music event, and the second object OBJ2 corresponds to a synthesizer for playing. In FIG. 17, the entire display screen of the display device DISP corresponds to the first region FIRST REGION.

The representation control unit 102 controls the representation using one or more virtual objects including the first object (St113). In the example of the present embodiment, the representation control unit 102 controls the representation using the first object OBJ1 and the second object OBJ2. For example, the content of the representation is holding a live music using a virtual object. The first object OBJ1 that corresponds to the artist and is displayed in AR sings, dances, and talks under control of the representation control unit 102. The second object OBJ2 that corresponds to the synthesizer and is displayed in AR emits a sound when played by the first object OBJ1 that is the artist. The representation is not limited to only a visual representation. Representations using various information that can be received by the user are available, such as an audible representation (sound of singing or a musical instrument and the like) and a tactile representation (for example, vibration made by a woofer).

FIG. 18 is a conceptual diagram illustrating a display example by the display device according to at least one embodiment of the present disclosure. In the example of the present embodiment, an outerwear of the first object OBJ1 displayed on the display device DISP can be purchased by the user as a product. That is, the outerwear corresponds to the product and other information that is information indicating the product or the service displayed on the display device.

In the example of the present embodiment, the user taps an outerwear part of the first object OBJ1 displayed on the display device DISP that is the touch panel display. This tapping corresponds to the input operation information provided by the user. The user terminal 20 transmits the input operation information to the server 10Z, and the permission acquisition information display unit 103 of the server 10Z acquires the input operation information (St115). The permission acquisition information display unit 103 displays permission acquisition information R1 and permission acquisition information R2 on the display device DISP (St116).

The permission acquisition information R1 and the permission acquisition information R2 in FIG. 18 are information for causing the user to acquire a permission to possess the product (outerwear) related to the first object OBJ1 corresponding to the artist. Here, the permission acquisition information R1 indicates product information (a product title, a product price, a product image, and the like) in a case of purchasing the outerwear and a Buy button for causing the user to express an intention to purchase correspond to the permission acquisition information. The user can purchase the outerwear by tapping the Buy button displayed on the display device DISP. In the example of the present embodiment, for example, the outerwear that is the product is mailed to home of the user under control of the server 10Z and the other server 40.

A display aspect of the permission acquisition information illustrated in FIG. 18 is merely an example. The permission acquisition information may be displayed in other aspects. For example, while the second region is dynamically displayed as a pop-up on the display device DISP, the first region and the second region may be separately displayed from the beginning. While the permission acquisition information is displayed in AR in FIG. 18, the permission acquisition information may not be displayed in AR. In addition, in FIG. 18, while the permission acquisition information is displayed in the second region different from the first region, the permission acquisition information may be displayed in the first region without providing the second region.

Furthermore, in FIG. 18, in a case where the server 10Z acquires the input operation information provided by the user, the permission acquisition information is displayed. However, the permission acquisition information may be displayed without acquiring the input operation information. For example, the permission acquisition information display unit 103 may display the permission acquisition information in a case where a predetermined condition is satisfied, such as displaying the permission acquisition information at a timing when the artist finishes singing a third song during a progress of the live music event. The predetermined condition is not limited to the above example. The predetermined condition may be any condition related to the object, the event, or the representation. For example, the predetermined condition may be a condition that the number of viewers of the live event is greater than or equal to 1,000 after 20 minutes from a start of the live event, or may be a condition that the artist mentions a costume of today during the live music.

FIG. 19 is a conceptual diagram illustrating a display example by the display device according to at least one embodiment of the present disclosure. FIG. 19 illustrates a case of displaying the permission acquisition information in the first region without providing the second region.

The user can purchase the synthesizer appearing in the live music event as a product. Thus, the second object OBJ2 that is displayed on the display device DISP and corresponds to the synthesizer corresponds to the product and other information. The user taps the displayed second object OBJ2. This tapping corresponds to the input operation information provided by the user. The user terminal 20 transmits the input operation information to the server 10Z, and the permission acquisition information display unit 103 of the server 10Z acquires the input operation information (St115). The permission acquisition information display unit 103 displays permission acquisition information R3 on the display device DISP (St116).

The permission acquisition information R3 in FIG. 19 is information for causing the user to acquire a permission to possess the synthesizer that is the product. That is, a speech balloon displayed above the second object OBJ2 as a pop-up and information indicating product information (a product title, a model number, a product price, and the like) displayed in the speech balloon correspond to the permission acquisition information. In the example of the present embodiment, the user can purchase the synthesizer by double-tapping the second object OBJ2. In the example of the present embodiment, the synthesizer that is the product is mailed to home of the user.

While the synthesizer in the above example corresponds to the product related to the second object, the synthesizer is also a product related to the live music event. The synthesizer can also be interpreted as a product related to the representation in the live music.

The product and other information may be information indicating a predetermined service. For example, when the user taps a part of a hand of the first object OBJ1 corresponding to the artist, information indicating a service “You can shake hands with the artist on a later date” may be displayed on the display device DISP. The content of the service is not limited to shaking hands, and various services are considered. For example, the first object OBJ1 may be an avatar used by a poster on a motion picture posting site, and a service for causing the avatar to appear in a predetermined animation program, a game, or the like may be employed.

FIG. 20 is a conceptual diagram illustrating a display example by the display device according to at least one embodiment of the present disclosure. FIG. 20 illustrates an example (step St111) in which the augmented reality diorama display unit 104 displays an augmented reality diorama ARD1 on the display device DISP. In the example of the present embodiment, a live stage in the live music event is displayed in AR as the augmented reality diorama. The first object OBJ1 is displayed on the display device DISP together with the augmented reality diorama ARD1.

FIG. 21 is a conceptual diagram illustrating a display example by the display device according to at least one embodiment of the present disclosure. FIG. 21 illustrates an example (step St111) in which an augmented reality diorama ARD2 is displayed in the second region of the display device DISP. The augmented reality diorama display unit 104 may display the augmented reality diorama ARD2 at a different timing from step St111 and may display the augmented reality diorama ARD2 without accompanying display of the first object OBJ1. In the example of the present embodiment, in FIG. 20 described above, in a case where the user taps the part (product and other information) of the outerwear of the first object OBJ1 displayed on the touch panel display, the display device DISP performs display as illustrated in FIG. 21. When the part (product and other information) of the outerwear of the first object OBJ1 is tapped, a text message or a voice message such as “Please come to the goods sales tent in order to purchase the product” may be output to the user terminal 20 or the display device under control of the server 10Z or the user terminal 20.

In FIG. 20, the user directs a tablet terminal that is the user terminal 20 to a direction of a TV at home. In FIG. 21, the user directs the tablet terminal to a direction opposite to the direction of the TV at home. Thus, a timepiece that is hung on a wall at home and is present in the real space is captured on the display device DISP. The augmented reality diorama ARD2 displayed on the display device DISP corresponds to a goods sales tent of a live festival event.

Permission acquisition information R4 in FIG. 21 is information for causing the user to acquire a permission to possess the product (outerwear) related to the first object OBJ1 corresponding to the artist. A speech balloon displayed as a pop-up and information indicating product information (a product title, a product price, a product image, and the like) displayed in the speech balloon correspond to the permission acquisition information R4. The permission acquisition information R4 is displayed by the display device DISP together with the augmented reality diorama ARD2. In the example of the present embodiment, the user can purchase the outerwear by double-tapping the speech balloon. In the example of the present embodiment, the outerwear that is the product is mailed to home of the user.

A cashier region RR and reception characters A1 to A5 are further displayed on the display device DISP. The cashier region RR and the reception characters A1 to A5 may be controlled by the server 10Z or the user terminal 20. In a case where the server 10Z controls the cashier region RR and the reception characters A1 to A5, the server 10Z may further include a cashier region display unit and a reception character display unit. In this case, the processor included in the server 10Z functionally implements the cashier region display unit and the reception character display unit by referring to the event provision program held (installed) in the storage device and executing the program.

The cashier region display unit has a function of displaying a virtual cashier region for causing the user to acquire the permission on the display device. The reception character display unit has a function of displaying one or more reception characters receiving the user on the display device together with the cashier region.

In the example in FIG. 21, the five reception characters A1 to A5 are arranged in the cashier region RR. Rock festival 2021 is virtually held in the augmented space, and the reception character A1 receives the user with respect to sales of official goods of Rock festival 2021. The reception character A2 receives the user with respect to sales of goods of the artist performing a performance on a wind stage among three stages of Rock festival 2021 displayable in AR. The reception character A3 receives the user with respect to sales of goods of the artist performing a performance on a sea stage among the three stages of Rock festival 2021 displayable in AR. The reception character A4 receives the user with respect to sales of goods of the artist performing a performance on a forest stage among the three stages of Rock festival 2021 displayable in AR. The reception character A5 receives the user with respect to a fan club registration service for all artists performing in Rock festival 2021. For example, the user can display (not illustrated) a list screen or the like on which products or services available for transaction are listed on the display device DISP by tapping the displayed reception character and perform transaction for a desired product or service. A user interface related to the transaction is not particularly limited and can be appropriately designed and implemented by those skilled in the art.

FIG. 22 is a conceptual diagram illustrating a display example by the display device according to at least one embodiment of the present disclosure. FIG. 22 illustrates a stage theatrical play event in which a story of fighting a dragon is staged in the AR space.

In the present embodiment, a display device DISP is the touch panel display included in the user terminal 20. However, as described above, the display device DISP may be incorporated in another apparatus such as the AR glasses or may be a display device connected to the other apparatus. A captured image captured by the camera (not illustrated) included in the user terminal 20 is displayed by the display device DISP. Thus, a television present in the real space is captured on the display device DISP. A dragon EN that is a virtual object is displayed on the display device DISP in a superimposed manner on the real space. The first object OBJ1 that is a virtual object is displayed on the display device DISP in a superimposed manner on the real space (step St112). The first object OBJ1 is a main character in the theatrical play of fighting with the dragon EN. An augmented reality diorama ARD3 corresponds to the stage of the stage theatrical play. In FIG. 22, the entire display screen of the display device DISP corresponds to the first region.

The representation control unit 102 controls the representation using one or more virtual objects including the first object (St113). In the example of the present embodiment, the representation control unit 102 controls the representation using the first object OBJ1 and the dragon EN. Here, the representation is holding a live stage theatrical play using a virtual object. The first object OBJ1 that corresponds to the main character and is displayed in AR fights the dragon EN also displayed in AR under control of the representation control unit 102. The content of the representation is not limited to only a visual representation. For example, representations using various information that can be received by the user are available, such as an audible representation (a BGM at a time of fighting) and a tactile representation (vibration when an attack hits an enemy).

FIG. 23 is a conceptual diagram illustrating a display example by the display device according to at least one embodiment of the present disclosure. The same matters as in FIG. 22 will not be described. In FIG. 23, the second region is provided on the display device DISP. In addition, a recommendation region RE is displayed on the display device DISP.

First, the recommendation region RE will be described. The recommendation information display unit 105 displays the recommendation information indicating the product or the service for which acquisition of the permission by the user is recommended, on the display device in accordance with the content of the representation using one or more virtual objects including the first object, the input information provided by the user, or the predetermined accumulated information (St114). In FIG. 23, the recommendation information is displayed in the recommendation region RE.

In the recommendation region RE illustrated in FIG. 23, the recommendation information indicating a service for enabling the first object OBJ1 that is the main character to be equipped with a shield for defending a body from an attack of the dragon is displayed in accordance with the content of the representation using the first object OBJ1, that is, a content “story of fighting a dragon”.

In addition, the recommendation information indicating a service for playing back a song “rising dragon” sung by an artist “Mr. SEJ” as a BGM during the play is displayed in the recommendation region RE in accordance with a character string “theme song” input as a text by the user through the user terminal 20. The recommendation information may be displayed in a form of an artwork or the like including an icon having a musical note shape, an artist name, and a song title. However, the display form is not limited thereto. In the example of the present embodiment, the fictional artist “Mr. SEJ” is assumed to be a person who sings an ending theme song (song different from “rising dragon”) in an animation version of a stage “AR quest”. In addition, performance information (voice acting, a production company, a theme song, and the like) of the stage “AR quest” is stored in the storage device accessible from the server 10Z as the accumulated information. The recommendation information indicating a figure that is official goods of the artist “Mr. SEJ” involved in the stage “AR quest” is displayed in the recommendation region RE based on the accumulated information.

The recommendation information is information indicating a product or a service and thus, also corresponds to the product and other information that is information indicating the product or the service displayed on the display device. Thus, in a case where the user taps the recommendation information displayed in the recommendation region RE, the permission acquisition information display unit 103 displays permission acquisition information R5 and permission acquisition information R6 on the display device DISP based on the input operation information related to the tapping.

The permission acquisition information R5 and the permission acquisition information R6 in FIG. 23 are information for causing the user to acquire a permission to receive a service for playing back the song “rising dragon” as a BGM during the play. That is, the artwork indicating the song and the Buy button for causing the user to express an intention to purchase correspond to the permission acquisition information. The user can view the song by playing back the song by streaming by swiping the artwork (permission acquisition information R5) to the Buy button (permission acquisition information R6). The display aspect of the permission acquisition information illustrated in FIG. 23 is merely an example, and other display aspects may be employed.

Here, the representation control unit 102 has a function of controlling the representation depending on whether or not the permission is acquired. In the example of the present embodiment, in a case where the user acquires a permission to receive a service for playing back the song “rising dragon” as a BGM during the play, the server 10Z acquires information indicating that the user acquires the permission, and the representation control unit 102 switches the BGM of the stage “AR quest” from another song to “rising dragon” in accordance with the information. In addition, the representation control unit 102 causes the main character to bow by controlling an action of the first object OBJ1 that is the main character. For example, in such a manner, the representation control unit 102 may change the content of the representation depending on whether or not the permission is acquired. Changing of the content of the representation is not limited to changing of the BGM or a predetermined action performed by the object. For example, development of the story may branch depending on whether or not the permission is acquired. A virtual article appearing in the stage theatrical play event may be changed depending on whether or not the permission is acquired. For example, for the user who acquires a permission to use a shield, the first object OBJ1 that is the main character of the play is provided with the shield. For example, for the user who acquires a permission to use a sword, the first object OBJ1 that is the main character of the play is provided with the sword. In a case of the live music event or the like, a song (program) sung by an artist may be changed depending on whether or not the permission is acquired. An attribute of a virtual object such as the first object used in the representation may be changed depending on whether or not the permission is acquired. For example, in a case where the first object is an avatar, “voice quality” that is an attribute of the avatar may be changed. For example, the first object OBJ1 may speak with a voice of a voice actor A in a case where the user does not acquire the permission, and speak with a voice of a voice actor B in a case where the user acquires the permission. Accordingly, an individualized representation can be provided in accordance with a purchase action or the like of the user while a basically uniform representation is provided to the participants of the event.

The user may acquire the permission at a timing other than during a progress of the representation. For example, the user may acquire the permission one week before the live event performed by displaying the first object OBJ1 in AR is held. The user purchases the product in advance and transmits the product information of the product delivered to home to the server 10Z through the user terminal 20 or the like. A method of transmitting the product information to the server 10Z is not particularly limited. For example, the user terminal 20 reads data from the product by causing an NFC tag embedded in the product to touch the user terminal 20. The processor included in the user terminal 20 generates the product information based on the read data and transmits the product information to the server 10Z. Alternatively, the user terminal 20 may generate the product information by reading a barcode attached to the product using a barcode reader and transmit the product information to the server 10Z. Besides, the product information may be extracted by imaging the product using the camera included in the user terminal 20 and causing the user terminal 20 or the server 10Z to recognize an image of imaging data. In a case where the product information is transmitted to the server 10Z through the user terminal 20, the representation control unit 102 of the server 10Z can recognize that the user acquires the permission in the past. The representation control unit 102 may control the representation depending on whether or not the permission is acquired in the past.

Display of Permission Acquisition Information and Recommendation Information Along with Progress of Representation

Next, display of the permission acquisition information and the recommendation information along with the progress of the representation will be described. The permission acquisition information display unit 103 has a function of displaying the permission acquisition information on the display device in a display aspect based on the progress of the representation. The recommendation information display unit 105 has a function of displaying the recommendation information on the display device in a display aspect based on the progress of the representation.

For example, in a case of the live music event, the progress of the representation means that a state of the event changes such that the artist finishes singing a first song and starts singing a second song, starts a song again due to wrong lyrics, or appears again on the stage in response to an encore. In a case of the stage theatrical play event, the progress of the representation means that the state of the event changes such that a curtain rises, an actor appears, the story develops, or a scene switches.

For example, the display aspect means a display timing, a display position, a display color, a size of the display, a font of the display, whether or not an effect highlighting the display is present, whether or not an animation is used in the display, whether or not to perform the display in AR, whether to perform the display as a text or perform the display as a drawing, or whether or not an input provided by the user can be received in the display. The above is merely an example, and other display aspects are also considered.

FIG. 24 is a conceptual diagram illustrating a display example by the display device according to at least one embodiment of the present disclosure. FIG. 24 illustrates a scene after the first object OBJ1 that is the main character defeats the dragon EN.

In the recommendation region RE illustrated in FIG. 24, the recommendation information indicating a service for playing back a song “VICTORY” sung by the artist “Mr. SEJ” as a BGM during the play is displayed in accordance with the content of the representation using the first object OBJ1, that is, a content “dragon is defeated in the story of fighting the dragon”. That is, the permission acquisition information display unit 103 controls a display timing of the recommendation information about the song “VICTORY” based on a trigger that the first object OBJ1 that is the main character defeats the dragon EN during the progress of the stage theatrical play. In addition, the permission acquisition information display unit 103 controls the display aspect of the recommendation information about the song “VICTORY” such that text information and a frame line are highlighted in bold, based on a trigger that the first object OBJ1 that is the main character defeats the dragon EN during the progress of the stage theatrical play.

Besides, the permission acquisition information display unit 103 may display the recommendation information on the display device DISP in various display aspects based on a trigger of various conditions such that the artist finishes singing three songs and starts talking in the live music event, a predetermined number of seconds elapses from a climax scene in the live theatrical play event, and a certain opponent player uses a predetermined item in a fighting game event.

The second region illustrated in FIG. 24 is present on an upper left side of the display device DISP, and permission acquisition information R7 and permission acquisition information R8 are displayed in the second region. The permission acquisition information R7 and the permission acquisition information R8 are information for causing the user to acquire a permission to receive a service for playing back the song “VICTORY” as a BGM during the play. In a case where the permission acquisition information is displayed, there is a possibility that the permission acquisition information hinders the user from being immersed in the representation performed in the event. Therefore, in the example of the present embodiment, the permission acquisition information display unit 103 controls the display aspect such that display positions of the permission acquisition information R7 and the permission acquisition information R8 move from a left side (refer to FIG. 23) of the display device DISP to the upper left side (refer to FIG. 24) of the display device DISP, based on a trigger that the first object OBJ1 that is the main character defeats the dragon EN. That is, the permission acquisition information display unit 103 displays the permission acquisition information on the display device in a display aspect based on the progress of the representation.

An aspect of changing the display position of the permission acquisition information is not limited to the above aspect. For example, the permission acquisition information display unit 103 or the recommendation information display unit 105 may display the permission acquisition information (second region) or the recommendation information (recommendation region RE) on the display device DISP in a superimposed manner on another target captured on the display device DISP. The permission acquisition information or the recommendation information may be displayed in a non-transparent state. Accordingly, in the event such as a live music or a live theatrical play, a predetermined target that is not desired to be perceived by the user as the representation can be hidden by the permission acquisition information (second region) or the recommendation information (recommendation region RE).

For example, there is a representation that is performed by causing the object display unit 101 to display the first object OBJ1 on the display device DISP such that the first object OBJ1 is superimposed on motion picture data (includes data related to not only playback by downloading but also playback by streaming, live broadcasting distribution, and the like) in which the live event such as a live music or a live theatrical play performed in the real space is imaged. This representation can be interpreted as a mixed event in which the event in the real space is mixed with augmented reality. Examples of the predetermined target not desired to be perceived by the user as the representation include event staff arranged in the mixed event below the live stage in the real space. For example, the event staff waits by standing or crouching down below the stage and secures safety of an audience and the artist.

As an aspect of the seventh embodiment, an event using augmented reality can be held, and goods sales and service provision can be performed in the event.

As an aspect of the seventh embodiment, for example, in a case where the user expresses an intention to acquire the permission to purchase the product, the permission acquisition information can be displayed. Accordingly, a user not having an intention to acquire the permission can focus on participating in the event.

As an aspect of the seventh embodiment, by separating the first region used in the event and the second region in which purchase or the like of the product is performed, display for performing purchase or the like of the product does not hinder participation of the user in the event.

As an aspect of the seventh embodiment, different staging can be performed in the event depending on whether or not the user acquires the permission. Accordingly, even in a case where the event is basically the same, each user can experience different events, and the event can be individualized.

As an aspect of the seventh embodiment, the user can express an intention to acquire the permission in the augmented real space.

As an aspect of the seventh embodiment, the permission acquisition information can be displayed in an appropriate aspect with respect to the event.

As an aspect of the seventh embodiment, the venue in which the event is performed can be provided in the augmented real space, and the user can perform a free action such as participating in the event, purchasing an article, or receiving provision of the service at the event venue represented by augmented reality.

As an aspect of the seventh embodiment, an appropriate product or service can be recommended to the user in the event performed in the augmented real space.

As an aspect of the seventh embodiment, the recommendation information can be displayed in an appropriate aspect with respect to the event.

As described above, each embodiment of the present application solves one or two or more deficiencies. Effects of each embodiment are non-limiting effects or an example of effects.

In each embodiment, the plurality of user terminals 20 and 20A to 20C and the server 10 execute the above various processes in accordance with various control programs (for example, the event provision program) stored in the respective storage devices thereof.

In addition, the configurations of the event provision system 100 and the event provision system 100A are not limited to the configurations described as an example of each embodiment. For example, a part or all of the processes described as a process executed by the user terminal may be configured to be executed by the server 10. A part or all of the processes described as a process executed by the server 10 may be configured to be executed by any of the plurality of user terminals 20 and 20A to 20C. In addition, a part or the entire storage unit (storage device) included in the server 10 may be configured to be included in any of the plurality of user terminals 20 and 20A to 20C. That is, a part or all of the functions included in any one of the user terminal and the server in the event provision system 100 or the event provision system 100A may be configured to be included in the other.

In addition, the program may be caused to implement a part or all of the functions described as an example of each embodiment in a single apparatus not including the communication network.

### Appendix

The above description of the embodiments is disclosed in order for those of ordinary knowledge in the field of the disclosure to embody at least the following disclosure.

[1]

An event provision program causing a server to implement an object display function of displaying a first object that is a virtual object on a display device in a superimposed manner on a real space, a representation control function of controlling a representation using one or more virtual objects including the first object, and a permission acquisition information display function of displaying information (hereinafter, referred to as “permission acquisition information”) for causing a user to acquire a predetermined permission for a product or a service related to the object, the event, or the representation on the display device.

[2]

The event provision program according to [1], in which in the permission acquisition information display function, a function of displaying the permission acquisition information on the display device in a case where input operation information provided by the user with respect to product and other information that is information indicating the product or the service displayed on the display device is acquired is implemented.

[3]

The event provision program according to [1] or [2], in which in the permission acquisition information display function, a function of displaying the permission acquisition information in a second region different from a first region in which the first object is displayed on the display device is implemented.

[4]

The event provision program according to any one of [1] to [3], in which in the representation control function, a function of controlling the representation depending on whether or not the permission is acquired is implemented.

[5]

The event provision program according to any one of [1] to [4], in which the permission acquisition information is displayed in a superimposed manner on the real space.

[6]

The event provision program according to any one of [1] to [5], in which in the permission acquisition information display function, a function of displaying the permission acquisition information on the display device in a display aspect based on a progress of the representation is implemented.

[7]

The event provision program according to any one of [1] to [6], further causing the server to implement an augmented reality diorama display function of displaying an augmented reality diorama superimposed on the real space on the display device, in which at least one of the first object and the permission acquisition information is displayed by the display device together with the augmented reality diorama.

[8]

The event provision program according to any one of [1] to [7], further causing the server to implement a recommendation information display function of displaying recommendation information indicating a product or a service for which acquisition of the permission by the user is recommended, on the display device in accordance with a content of the representation, input information provided by the user, or predetermined accumulated information.

[9]

The event provision program according to [8], in which in the recommendation information display function, a function of displaying the recommendation information on the display device in a display aspect based on a progress of the representation is implemented.

[10]

A program causing a user terminal capable of communicating with the server to implement at least one function of the functions that the server is caused to implement by the event provision program according to any one of [1] to [9].

[11]

A server on which the event provision program according to any one of [1] to [9] is installed.

[12]

An event provision system including a communication network, a server, and a user terminal, the event provision system including object display means for displaying a first object that is a virtual object on a display device in a superimposed manner on a real space, representation control means for controlling a representation using one or more virtual objects including the first object, and permission acquisition information display means for displaying information (hereinafter, referred to as “permission acquisition information”) for causing a user to acquire a predetermined permission for a product or a service related to the object, the event, or the representation on the display device.

[13]

An event provision program causing a user terminal to implement an object display function of displaying a first object that is a virtual object on a display device in a superimposed manner on a real space, a representation control function of controlling a representation using one or more virtual objects including the first object, and a permission acquisition information display function of displaying information (hereinafter, referred to as “permission acquisition information”) for causing a user to acquire a predetermined permission for a product or a service related to the object, the event, or the representation on the display device.

[14]

A user terminal on which the event provision program according to [13] is installed.

[15]

An event provision program causing a computer apparatus to implement an object display function of displaying a first object that is a virtual object on a display device in a superimposed manner on a real space, a representation control function of controlling a representation using one or more virtual objects including the first object, and a permission acquisition information display function of displaying information (hereinafter, referred to as “permission acquisition information”) for causing a user to acquire a predetermined permission for a product or a service related to the object, the event, or the representation on the display device.

[16]

An event provision method by a computer apparatus, the event provision method including an object display process of displaying a first object that is a virtual object on a display device in a superimposed manner on a real space, a representation control process of controlling a representation using one or more virtual objects including the first object, and a permission acquisition information display process of displaying information (hereinafter, referred to as “permission acquisition information”) for causing a user to acquire a predetermined permission for a product or a service related to the object, the event, or the representation on the display device.

[17]

An event provision method by an event provision system including a communication network, a server, and a user terminal, the event provision method including an object display process of displaying a first object that is a virtual object on a display device in a superimposed manner on a real space, a representation control process of controlling a representation using one or more virtual objects including the first object, and a permission acquisition information display process of displaying information (hereinafter, referred to as “permission acquisition information”) for causing a user to acquire a predetermined permission for a product or a service related to the object, the event, or the representation on the display device.

### INDUSTRIAL APPLICABILITY

One embodiment of the present disclosure is useful as a non-transitory computer readable medium storing an event provision program that enables an event using augmented reality to be held and enables goods sales and service provision in the event, and an event provision system.

What is claimed is:

1. A non-transitory computer readable medium storing a program for providing an event causing a server to perform:
displaying a virtual object superimposed on a view of a real space on a display device;
controlling a representation that includes one or more virtual objects including the virtual object; and
displaying authority obtaining information allowing a user to obtain a predetermined authority over at least one of a product or a service related to the object, the event, or the representation on the display device.

2. The non-transitory computer readable medium according to claim 1,
wherein displaying authority obtaining information comprises displaying the authority obtaining information on the display device if information of an input operation by the user is obtained, the input operation by the user being with respect to information indicating the product or the service displayed on the display device.

3. The non-transitory computer readable medium according to claim 1,
wherein displaying authority obtaining information comprises displaying the authority obtaining information in a second region different from a first region including the virtual object on the display device.

4. The non-transitory computer readable medium according to claim 1,
wherein controlling the representation comprises controlling the representation depending on whether the authority is obtained.

5. The non-transitory computer readable medium according to claim 1, wherein displaying authority obtaining information comprises superimposing the authority obtaining information on the view of the real space.

6. The non-transitory computer readable medium according to claim 1, wherein displaying authority obtaining information comprises displaying the authority obtaining information on the display device in a display mode based on a progress of the representation.

7. The non-transitory computer readable medium according to claim 1, the program further causing the server to perform displaying an augmented reality diorama superimposed on the view of the real space on the display device, in which at least one of the virtual object and the authority obtaining information is displayed by the display device together with the augmented reality diorama.

8. The non-transitory computer readable medium according to claim 1, the program further causing the server to perform displaying recommendation information indicating a product or a service on the display device in accordance with at least one of a content of the representation, input information provided by the user, or predetermined accumulated information.

9. The non-transitory computer readable medium according to claim 8, wherein displaying the recommendation information comprises displaying the recommendation information on the display device in a display mode based on a progress of the representation.

10. An event provision system comprising:
a communication network;
a server;
a user terminal; and
one or more computers in at least one of the server or the user terminal configured to:
display a virtual object superimposed on a view of a real space on a display device;
control a representation that includes one or more virtual objects including the virtual object; and
display authority obtaining information allowing a user to obtain a predetermined authority over at least one of a product or a service related to the object, the event, or the representation on the display device.

11. A non-transitory computer readable medium storing a program for providing an event causing a user terminal to perform:
displaying a virtual object superimposed on a view of a real space on a display device;
controlling a representation that includes one or more virtual objects including the virtual object; and
displaying authority obtaining information allowing a user to obtain a predetermined authority over at least one of a product or a service related to the object, the event, or the representation on the display device.
